(19) United States
(12) Patent Application Publication
(10) Pub. No.: US 2026/0259948 A1
(43) Pub. Date: Sep. 3, 2026

(54) SYSTEM AND METHOD FOR PROVIDING A DATA ANALYTICS ASSISTANT INCLUDING LLM-ASSISTED ASSESSMENT OF USER INPUT

(71) Applicant: ORACLE INTERNATIONAL CORPORATION, Redwood Shores, CA (US)

(72) Inventors: Jacques Vigeant, Fort Lauderdale, FL (US); Bret Grinslade, Sammamish, WA (US)

(21) Appl. No.: 19/539,429

(22) Filed: Feb. 13, 2026

Related U.S. Application Data
(60) Provisional application No. 63/764,937, filed on Feb. 28, 2025.

(51) Int. Cl. G06F 16/9535; G06F 16/242; G06F 16/2457; G06F 16/248

(52) U.S. Cl. CPC G06F 16/9535; G06F 16/243; G06F 16/24578; G06F 16/248

(57) ABSTRACT

Embodiments described herein are generally related to computer data analytics, and computer-based methods of providing analytics data, and are particularly directed to providing a data analytics assistant that includes the use of an LLM in assessing and responding to user input. In accordance with an embodiment, the system includes an LLM-assisted user input assessment component and user interface that allows the user to enter a user input in the form of a natural language query or request. In response to said user input, the system operates to find data assets with an affinity to the original, e.g., query or request, based on their vector similarity; determine an intent associated with the query or request; tune the query or request for use in addressing the determined intent; and route the LLM-augmented query or request for subsequent handling, for example to query a dataset or provide a data analytics or visualization.

### CLAIM OF PRIORITY

The present application claims the benefit of priority to U.S. Provisional Patent Application titled "SYSTEM AND METHOD FOR PROVIDING A DATA ANALYTICS WORKBOOK ASSISTANT", Application No. 63/764,937, filed February 28, 2025; which application and the contents thereof are herein incorporated by reference.

### TECHNICAL FIELD

Embodiments described herein are generally related to computer-based methods of providing analytics data, and are particularly directed to providing a data analytics assistant that includes the use of an LLM in assessing and responding to user input.

### BACKGROUND

Data analytics enables computer-based examination of large amounts of data, for example to derive conclusions or other information from the data. For example, business intelligence tools can be used to provide users with business intelligence describing their enterprise data, in a format that enables the users to make strategic business decisions.

Some approaches to natural-language-driven data analytics require that specific forms of natural language questions be set up within the system in advance, which a user can then select from or invoke to obtain various answers.

In other systems that support the use of language models to analyze data files, a user may be required to provide particular data files and then explicitly request the language model to answer specific questions, for example to identify particular data trends associated with those files.

Such approaches and systems generally lack the flexibility to accommodate new sources of data, or free-flowing question-and-answer forms of interaction or data analysis.

### SUMMARY

Embodiments described herein are generally related to computer data analytics, and computer-based methods of providing analytics data, and are particularly directed to providing a data analytics assistant that includes the use of an LLM in assessing and responding to user input.

In accordance with an embodiment, the system includes an LLM-assisted user input assessment component and user interface that allows the user to enter a user input in the form of a natural language query or request.

In response to said user input, the system operates to Find, by reference to a vector database or vector store, data assets with an affinity to the original, e.g., query or request, based on their vector similarity; determine, based on processing of the query or request by an LLM, an intent associated therewith; tune, augment, or otherwise adjust based on found data assets and responses received from the LLM, the query or request for use in addressing the determined intent; and route the LLM-augmented query or request for subsequent handling, for example to query a dataset or provide a data analytics or visualization.

In accordance with an embodiment, the system operates as a data analytics assistant that provides natural language processing capabilities, for purposes of generating, modifying, or interacting with data visualizations, or generating a story or script that includes or is descriptive of the data visualizations

In accordance with an embodiment, the system operating as a data analytics assistant incorporates the use of the large language model (LLM) in the manner of a front-end mechanism to assess a user’s natural language input and determine an associated intent, based on semantic similarity with available data assets, such as data catalogs or datasets.

In accordance with an embodiment, a user’s natural language input is assessed based on vector similarity, and appropriate matches can be returned, even if the specific terms used in a catalog or dataset description are not specifically indicated in the original user input.

In accordance with an embodiment, the system can determine relevant items in a catalog in reference to a received user input, and provide recommendations or narratives associated with the results, for use by the system in automatically generating in real-time a story, podcast, or other form of narrative output or presentation.

### BRIEF DESCRIPTION OF THE DRAWINGS

FIG. 1 illustrates a system for providing a computing environment, such as a cloud infrastructure or data analytics environment, in accordance with an embodiment.

FIG. 2 further illustrates a system for providing a computing environment, such as a cloud infrastructure or data analytics environment, in accordance with an embodiment.

FIG. 3 illustrates an example use of the system to provide a data analytics environment, in accordance with an embodiment.

FIG. 4 further illustrates an example data analytics environment, in accordance with an embodiment.

FIG. 5 further illustrates an example data analytics environment, in accordance with an embodiment.

FIG. 6 further illustrates an example data analytics environment, in accordance with an embodiment.

FIG. 7 further illustrates an example data analytics environment, in accordance with an embodiment.

FIG. 8 further illustrates an example data analytics environment, in accordance with an embodiment.

FIG. 9 further illustrates an example data analytics environment, including the use of a machine learning environment, for example a large language model, in accordance with an embodiment.

FIG. 10 further illustrates an example data analytics environment, including the use of a retrieval-augmented generation process, in accordance with an embodiment.

FIG. 11 illustrates a use of the system to transform, analyze, or visualize data, in accordance with an embodiment.

FIG. 12 illustrates a system for providing digital assistant integration with a data analytics assistant, in accordance with an embodiment.

FIG. 13 illustrates the use of a natural language generator service to support digital assistant integration, in accordance with an embodiment.

FIG. 14 illustrates the use of a provider framework to support digital assistant integration, in accordance with an embodiment.

FIG. 15 illustrates the use of a large language model (LLM) in assessing user input, in accordance with an embodiment.

FIG. 16 illustrates the use of a large language model (LLM) in assessing user input, in accordance with an embodiment.

FIG. 17 further illustrates the use of a large language model (LLM) in assessing user input, in accordance with an embodiment.

FIG. 18 further illustrates the use of a large language model (LLM) in assessing user input, in accordance with an embodiment.

FIG. 19 further illustrates the use of a large language model (LLM) in assessing user input, in accordance with an embodiment.

FIG. 20 further illustrates the use of a large language model (LLM) in assessing user input, in accordance with an embodiment.

FIG. 21 further illustrates the use of a large language model (LLM) in assessing user input, in accordance with an embodiment.

FIG. 22 illustrates a method for use of a large language model (LLM) in assessing user input, in accordance with an embodiment.

FIG. 23 illustrates an embodiment in which an LLM can be used in assessing user input, in accordance with an embodiment.

FIG. 24 further illustrates an embodiment in which an LLM can be used in assessing user input, in accordance with an embodiment.

FIG. 25 further illustrates an embodiment in which an LLM can be used in assessing user input, in accordance with an embodiment.

FIG. 26 further illustrates an embodiment in which an LLM can be used in assessing user input, in accordance with an embodiment.

FIG. 27 further illustrates an embodiment in which an LLM can be used in assessing user input, in accordance with an embodiment.

FIG. 28 further illustrates an embodiment in which an LLM can be used in assessing user input, in accordance with an embodiment.

FIG. 29 further illustrates an embodiment in which an LLM can be used in assessing user input, in accordance with an embodiment.

FIG. 30 further illustrates an embodiment in which an LLM can be used in assessing user input, in accordance with an embodiment.

FIG. 31 further illustrates an embodiment in which an LLM can be used in assessing user input, in accordance with an embodiment.

FIG. 32 further illustrates an embodiment in which an LLM can be used in assessing user input, in accordance with an embodiment.

FIG. 33 further illustrates an embodiment in which an LLM can be used in assessing user input, in accordance with an embodiment.

FIG. 34 further illustrates an embodiment in which an LLM can be used in assessing user input, in accordance with an embodiment.

### DETAILED DESCRIPTION

Generally described, data analytics enables computer-based examination of large amounts of data, for example to derive conclusions or other information from the data. For example, business intelligence tools can be used to provide users with business intelligence describing their enterprise data, in a format that enables the users to make strategic business decisions.

Increasingly, data analytics can be provided within the context of enterprise software application environments, such as, for example, an Oracle Fusion Applications environment; or within the context of software-as-a-service (SaaS) or cloud environments, such as, for example, an Oracle Analytics Cloud or Oracle Cloud Infrastructure environment; or other types of analytics application or cloud environments.

Examples of data analytics environments and business intelligence tools/servers include Oracle Business Intelligence Server (OBIS), Oracle Analytics Cloud (OAC), and Fusion Analytics Warehouse (FAW), which support features such as data mining or analytics, and analytic applications.

Some approaches to natural-language-driven data analytics require that specific forms of natural language questions be set up within the system in advance, which a user can then select from or invoke to obtain various answers.

In other systems that support the use of language models to analyze data files, a user may be required to provide particular data files and then explicitly request the language model to answer specific questions, for example to identify particular data trends associated with those files.

Such approaches and systems generally lack the flexibility to accommodate new sources of data, or free-flowing question-and-answer forms of interaction or data analysis.

Embodiments described herein are generally related to computer data analytics, and computer-based methods of providing analytics data, and are particularly directed to providing a data analytics assistant that includes the use of an LLM in assessing and responding to user input.

In accordance with an embodiment, the system includes an LLM-assisted user input assessment component and user interface that allows the user to enter a user input in the form of a natural language query or request.

In response to said user input, the system operates to Find, by reference to a vector database or vector store, data assets with an affinity to the original, e.g., query or request, based on their vector similarity; determine, based on processing of the query or request by an LLM, an intent associated therewith; tune, augment, or otherwise adjust based on found data assets and responses received from the LLM, the query or request for use in addressing the determined intent; and route the LLM-augmented query or request for subsequent handling, for example to query a dataset or provide a data analytics or visualization.

In accordance with various embodiments, technical advantages of the described approach include, for example, that since a user’s natural language input can be assessed based on vector similarity, appropriate matches can be returned, even if the specific terms used in a dataset description are not specifically indicated in the original user input. If upon assessing a user input, a particular data catalog or dataset does not include an explicitly-defined description, the system can automatically generate a description - effectively allowing a data catalog or dataset to be self-describing.

As an additional example, in accordance with an embodiment, in response to a user input to the system to generate a chart, the system can use one or more LLMs to generate an interaction with the user, locate or find a dataset that has a high affinity to the user input, and tune or augment the user input for use with the dataset so that the resulting query is best directed to an appropriate dataset or associated metric. The user input (e.g., question, or request) as tuned can then be processed directly by the data analytics assistant (e.g., as may be provided within an Oracle Analytics Cloud (OAC) or other data analytics environment) or provided to a query engine for further processing.

The above technical advantages are provided by way of illustration; in accordance with various embodiments as described herein, additional technical advantages can be provided.

### Cloud Infrastructure and Data Analytics Environments

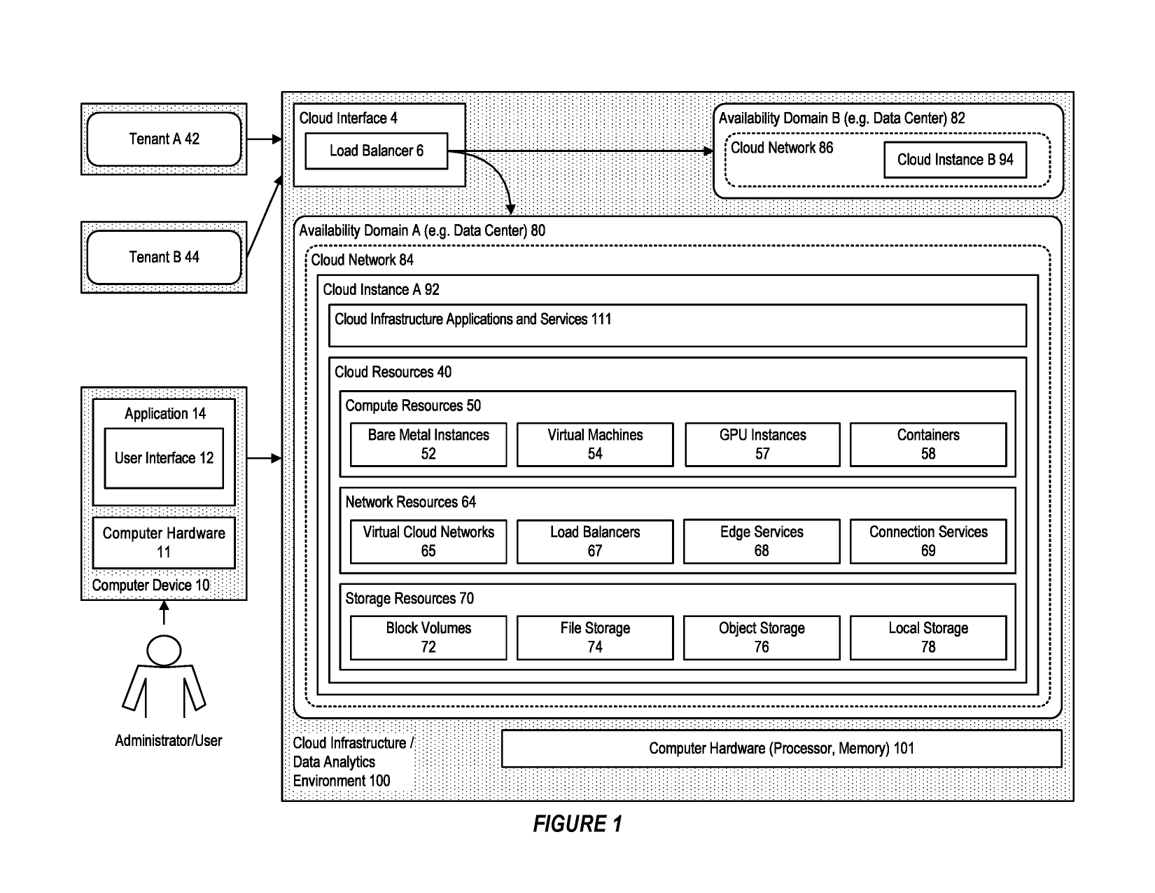

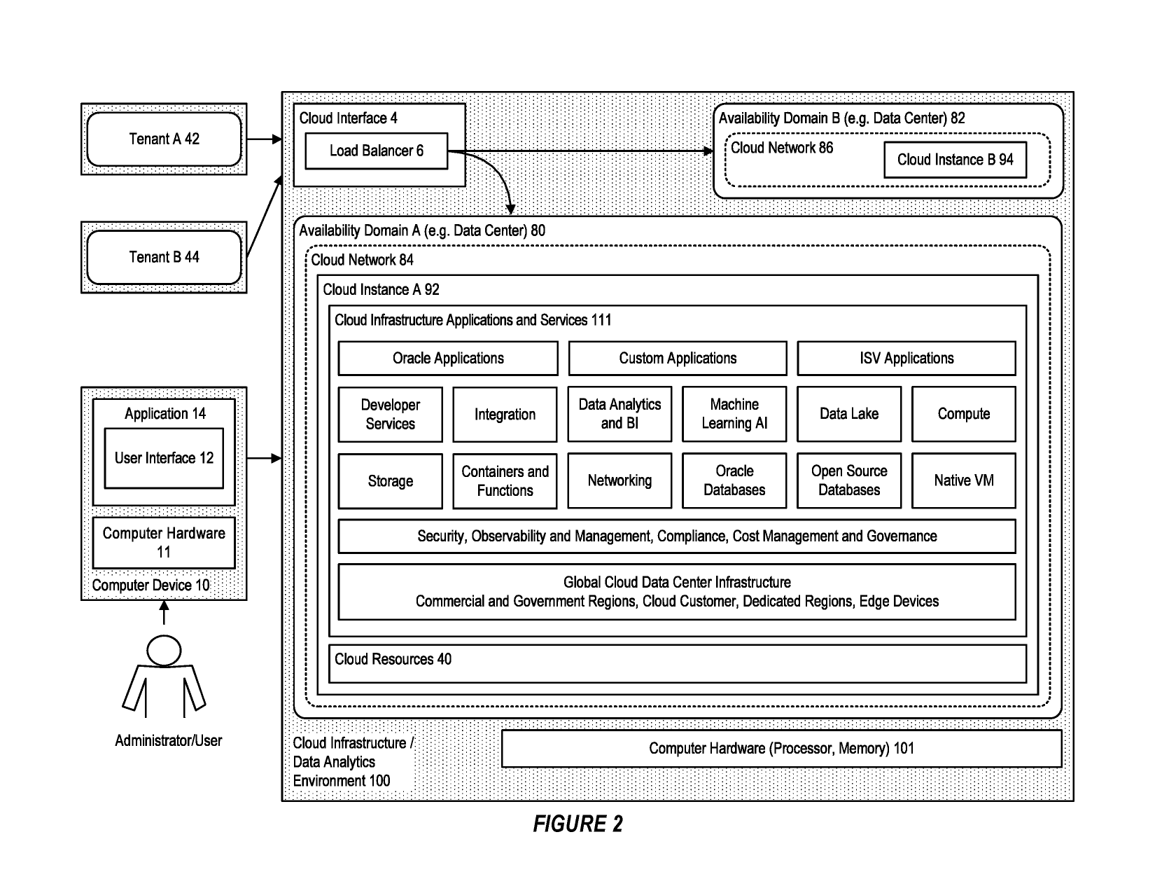

FIGS. 1 and 2 illustrate a system for providing a computing environment, such as a cloud infrastructure or data analytics environment, in accordance with an embodiment.

In accordance with an embodiment, the components and processes illustrated in FIG. 1, and as further described herein with regard to various embodiments, can be provided as software or program code executable by a computer system or other type of processing device, for example a cloud computing system, or other suitably-programmed computer system.

The illustrated example is provided for purposes of illustrating a computing environment which can be used to provide cloud environments for use by tenants in accessing subscription-based software products, services, or other offerings associated with a cloud infrastructure environment. In accordance with other embodiments, the various components, processes, and features described herein can be used with other types of cloud computing environments.

As illustrated in FIG. 1, in accordance with an embodiment, a cloud infrastructure or data analytics environment 100 can operate on a cloud computing infrastructure 101 comprising hardware (e.g., processor, memory), software resources, and one or more cloud interfaces 4 or other application program interfaces (API) that provide access to the shared cloud resources via one or more load balancers 6.

In accordance with an embodiment, the cloud infrastructure environment supports the use of availability domains, such as, for example, availability domains A 80, B 82, which enables customers to create and access cloud networks 84, 86, and run cloud instances A 92, B 94.

In accordance with an embodiment, a tenancy can be created for each cloud tenant/customer, for example tenant A 42, B 44, which provides a secure and isolated partition within the cloud infrastructure environment within which the customer can create, organize, and administer their cloud resources. A cloud tenant/customer can access an availability domain and a cloud network to access each of their cloud instances

In accordance with an embodiment, a client device, such as, for example, a computing device 10 having a device hardware 11 (e.g., processor, memory), application 14 and graphical user interface 12, can enable an administrator or other user to communicate with the cloud infrastructure environment via a network such as, for example, a wide area network, local area network, or the Internet, to create or update cloud services

In accordance with an embodiment, the cloud infrastructure environment provides access to shared cloud resources 40 via, for example, a compute resources layer 50, a network resources layer 64, and/or a storage resources layer 70. Customers can launch cloud instances as needed, to meet compute and application requirements. After a customer provisions and launches a cloud instance, the provisioned cloud instance can be accessed from, for example, a client device.

In accordance with an embodiment, the compute resources layer can comprise resources, such as, for example, bare metal cloud instances 52, virtual machines 54, graphics processing unit (GPU) compute cloud instances 57, and/or containers 58. The compute resources layer can be used to, for example, provision and manage bare metal compute cloud instances, or provision cloud instances as needed to deploy and run applications, as in an on-premises data center.

For example, in accordance with an embodiment, the cloud infrastructure environment can provide control of physical host (bare metal) machines within the compute resources layer, which run as compute cloud instances directly on bare metal servers, without a hypervisor.

In accordance with an embodiment, the cloud infrastructure environment can also provide control of virtual machines within the compute resources layer, which can be launched, for example, from an image, wherein the types and quantities of resources available to a virtual machine cloud instance can be determined, for example, based upon the image that the virtual machine was launched from.

In accordance with an embodiment, the network resources layer can comprise a number of network-related resources, such as, for example, virtual cloud networks (VCNs) 65, load balancers 67, edge services 68, and/or connection services 69.

In accordance with an embodiment, the storage resources layer can comprise a number of resources, such as, for example, data/block volumes 72, file storage 74, object storage 76, and/or local storage 78.

In accordance with an embodiment, the cloud environment can include a container orchestration system, and container orchestration system API, that enables containerized application workflows to be deployed to a container orchestration environment, for example a Kubernetes (k8s) cluster.

For example, in accordance with an embodiment, the cloud environment can be used to provide containerized compute cloud instances within the compute resources layer, and a container orchestration implementation (e.g., Oracle Cloud Infrastructure Container Engine for Kubernetes (OKE)), can be used to build and launch containerized applications or cloud-native applications, specify compute resources that the containerized application requires, and provision the required compute resources.

As illustrated in FIG. 2, in accordance with an embodiment, the cloud infrastructure or data analytics environment can include a range of complementary cloud-based components, for example as cloud infrastructure applications and services 111, that enable organizations or enterprise customers to operate their applications and services in a highly- available hosted environment.

By way of example, in accordance with an embodiment, a self-contained cloud region can be provided as a complete, e.g., Oracle Cloud Infrastructure (OCI) dedicated region within an organization's data center that offers the data center operator the agility, scalability, and economics of a public cloud, while retaining full control of their data and applications to meet security, regulatory, or data residency requirements.

### Data Analytics Environments

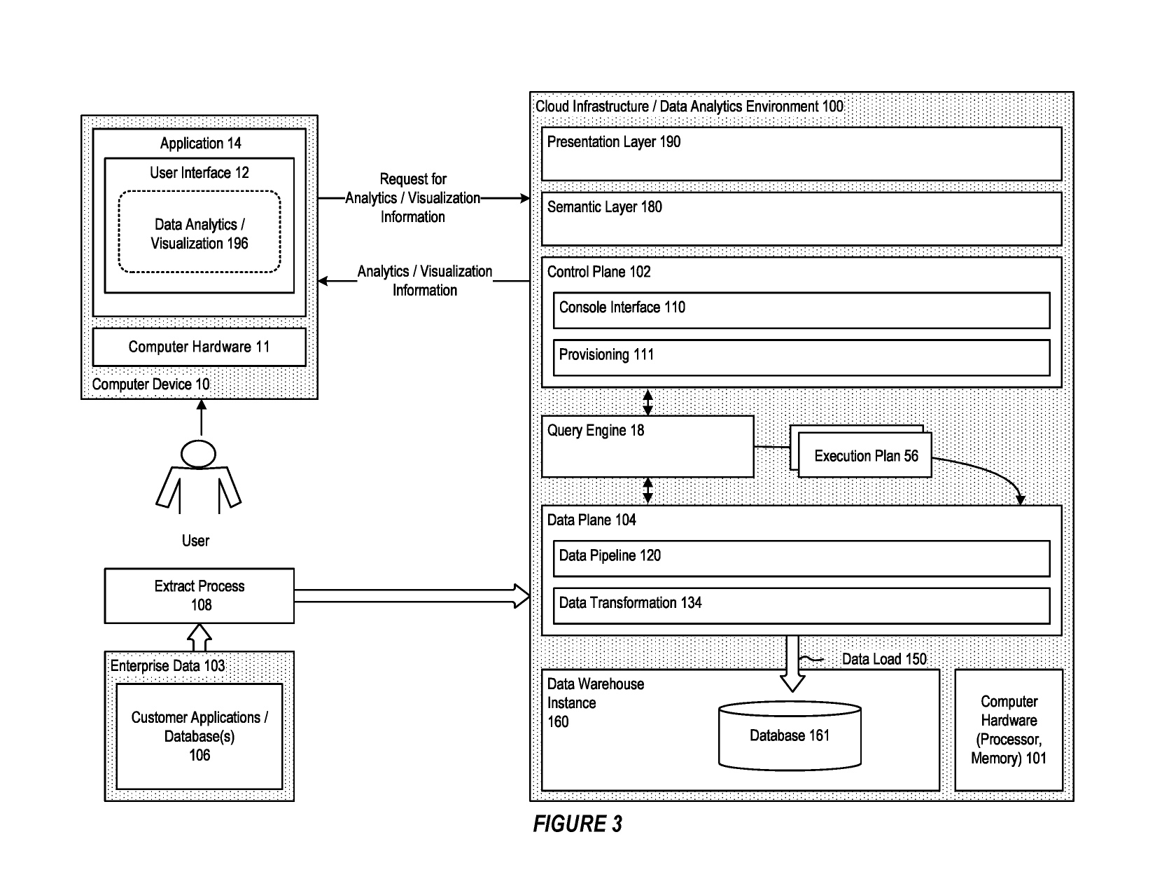

FIG. 3 illustrates an example use of the system to provide a data analytics environment, in accordance with an embodiment.

The example embodiment illustrated in FIG. 3 is provided for purposes of illustrating an example of a data analytics environment in association with which various embodiments described herein can be used. In accordance with other embodiments and examples, the approach described herein can be used with other types of data analytics, database, or data warehouse environments.

As illustrated in FIG. 3, in accordance with an embodiment, a data analytics environment 100 can be provided by, or otherwise operate at, a computer system having a computer hardware (e.g., processor, memory) 101, and including one or more software components operating as a control plane 102, and a data plane 104, and providing access in the manner of a data layer to a data warehouse instance 160 (e.g., having a database 161, or other type of data source).

In accordance with an embodiment, the control plane operates to provide control for cloud or other software products offered within the context of a cloud environment. For example, in accordance with an embodiment, the control plane can include a console interface 110 that enables access by a customer (tenant) and/or a cloud environment having a provisioning component 111, for example to allow customers to provision services for use within their enterprise environment. The provisioning component can provision a data warehouse instance, including a customer schema of the data warehouse; and populate the data warehouse instance with the appropriate information supplied by the customer.

In accordance with an embodiment, the data plane can include a data pipeline or process layer 120 and a data transformation layer 134, that together process data from an organization’s enterprise software environment, and load a transformed data into the data warehouse. The data transformation layer can include a data model, such as, for example, a knowledge model (KM), or other type of data model, that the system uses to transform the data received from business applications and corresponding databases, into a model format understood by the data analytics environment. The data plane is responsible for performing extract, transform, and load (ETL) operations, including extracting data from an organization’s enterprise software environment, transforming the extracted data into a model format, and loading the transformed data into a customer schema of the data warehouse.

For example, in accordance with an embodiment, each customer (tenant) of the environment can be associated with their own customer schema; and can be additionally provided with read-only access to the data analytics schema, which can be updated by a data pipeline or process, for example, an ETL process, on a periodic or other basis. For example, a data pipeline or process can be scheduled to execute at intervals (e.g., hourly/daily/weekly) to extract enterprise data 103 from an enterprise software environment, such as, for example, business productivity software applications and corresponding databases 106.

In accordance with an embodiment, an extract process 108 can extract the data, whereupon extraction the data pipeline or process can insert extracted data into a data staging area, which can act as a temporary staging area for the extracted data. When the extract process has completed its extraction, the data transformation layer can be used to transform the extracted data into a model format to be loaded into the customer schema of the data warehouse. During the data transformation, the system can perform dimension generation, fact generation, and aggregate generation, as appropriate. Dimension generation can include generating dimensions or fields for loading into the data warehouse instance.

In accordance with an embodiment, after transformation of the extracted data, the data pipeline or process can execute a warehouse load procedure 150, to load the transformed data into the customer schema of the data warehouse instance. Subsequent to the loading of the transformed data into customer schema, the transformed data can be analyzed and used in a variety of additional business intelligence processes.

Different customers may have different requirements with regard to how their data is classified, aggregated, or transformed, for providing data analytics or business intelligence data, or developing software analytic applications. In accordance with an embodiment, to support such different requirements, a semantic layer 180 can include data defining a semantic model of a customer’s data; which is useful in assisting users in understanding and accessing that data using commonly-understood business terms; and provide custom content to a presentation layer 190.

In accordance with an embodiment, a customer may perform modifications to their data source model, to support their particular requirements, for example by adding custom facts or dimensions associated with the data stored in their data warehouse instance; and the system can extend the semantic model accordingly. A semantic model can be defined, for example, in an Oracle environment, as a BI Repository (RPD) file, having metadata that defines logical schemas, physical schemas, physical-to-logical mappings, aggregate table navigation, and/or other constructs that implement the various physical layer, business model and mapping layer, and presentation layer aspects of the semantic model.

In accordance with an embodiment, the presentation layer can enable access to the data content using, for example, a software analytic application, user interface, analytics dashboard, key performance indicators (KPIs); or other type of report or interface as may be provided by products such as, for example, Oracle Analytics Cloud, or Oracle Analytics for Applications.

In accordance with an embodiment, a query engine 18 (e.g., an Oracle Business Intelligence Server, OBIS instance) operates in the manner of a federated query engine to serve analytical queries or requests from clients directed to data stored at a database. The query engine can push down operations to supported databases, in accordance with a query execution plan 56, wherein a logical query can include Structured Query Language (SQL) statements received from the clients; while a physical query includes database-specific statements that the query engine sends to the database to retrieve data when processing the logical query.

In accordance with an embodiment, a user/developer can interact with a client computer device 10 that includes a computer hardware 11 (e.g., processor, storage, memory), user interface 12, and client application 14. A query engine or business intelligence server generally operates to process inbound, e.g., SQL, requests against a database model, build and execute one or more physical database queries, process the data appropriately, and return an appropriate data in response to the original query or request.

To accomplish this, in accordance with an embodiment, the query engine can include a logical or business model, or metadata, that describes the data available as subject areas for queries; a request generator that takes incoming queries and turns them into physical queries for use with a connected data source; and a navigator that takes the incoming query, navigates the logical model and generates those physical queries that best return the data required for a particular query.

For example, in accordance with an embodiment, the query engine may employ a logical model mapped to data in a data warehouse, by creating a simplified star schema business model over various data sources so that the user can query data as if it originated at a single source. The information can then be returned to the presentation layer as subject areas, according to business model layer mapping rules.

In accordance with an embodiment, the query engine can process queries against a database according to a query execution plan. During operation, the query engine can create a query execution plan which can then be further optimized, for example to perform aggregations of data necessary to respond to a request. Data can be combined together and further calculations applied before the results are returned to the calling application.

In accordance with an embodiment, a request for data analytics or visualization information can be received via a client application and user interface as described above and communicated to the data analytics environment (in the example of a cloud environment, via a cloud service). The system can retrieve an appropriate dataset to address the user/business context, for use in generating and returning the requested data analytics or visualization information to the client, as a data visualization 196.

In accordance with an embodiment, a client application can be implemented as software or computer-readable program code executable by a computer system or processing device, and having a user interface, such as, for example, a software application user interface or a web browser interface. The client application can retrieve or access data via an Internet/HTTP or other type of network connection to the data analytics environment, or in the example of a cloud environment via a cloud service provided by the environment.

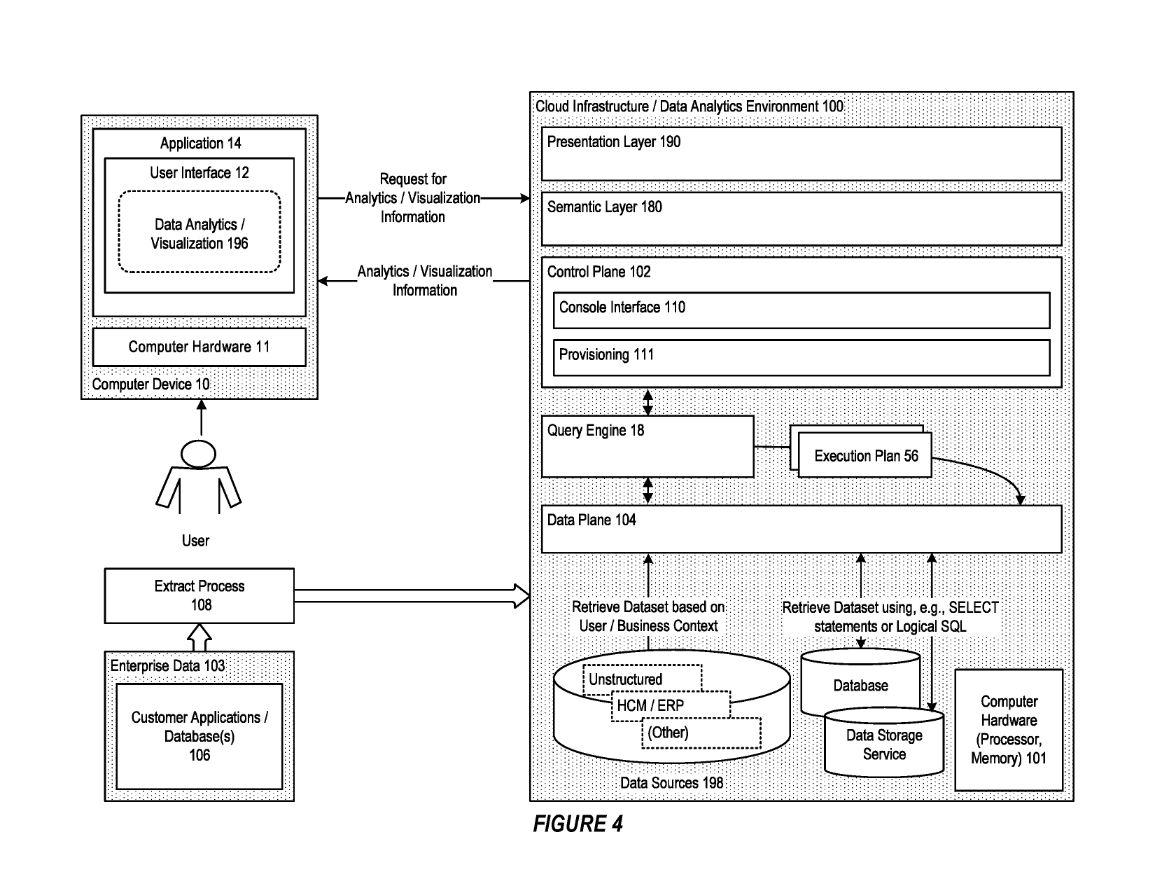

FIG. 4 further illustrates an example data analytics environment, in accordance with an embodiment.

As illustrated in FIG. 4, in accordance with an embodiment, the data analytics environment enables a dataset to be retrieved, received, or prepared from one or more data source(s) 198, for example via one or more data source connections. Examples of the types of data that can be transformed, analyzed, or visualized using the systems and methods described herein include data directed to Enterprise Resource Planning (ERP), Human Capital Management (HCM), or Human Resources (HR), or other types of data provided at one or more of a database, data storage service, or other type of data repository or data source.

For example, in accordance with an embodiment, a request for data analytics or visualization information can be received via a client application and user interface as described above, and communicated to the data analytics environment, for example via a cloud service. The system can retrieve an appropriate dataset to address the user/business context, for use in generating and returning the requested data analytics or visualization information to the client.

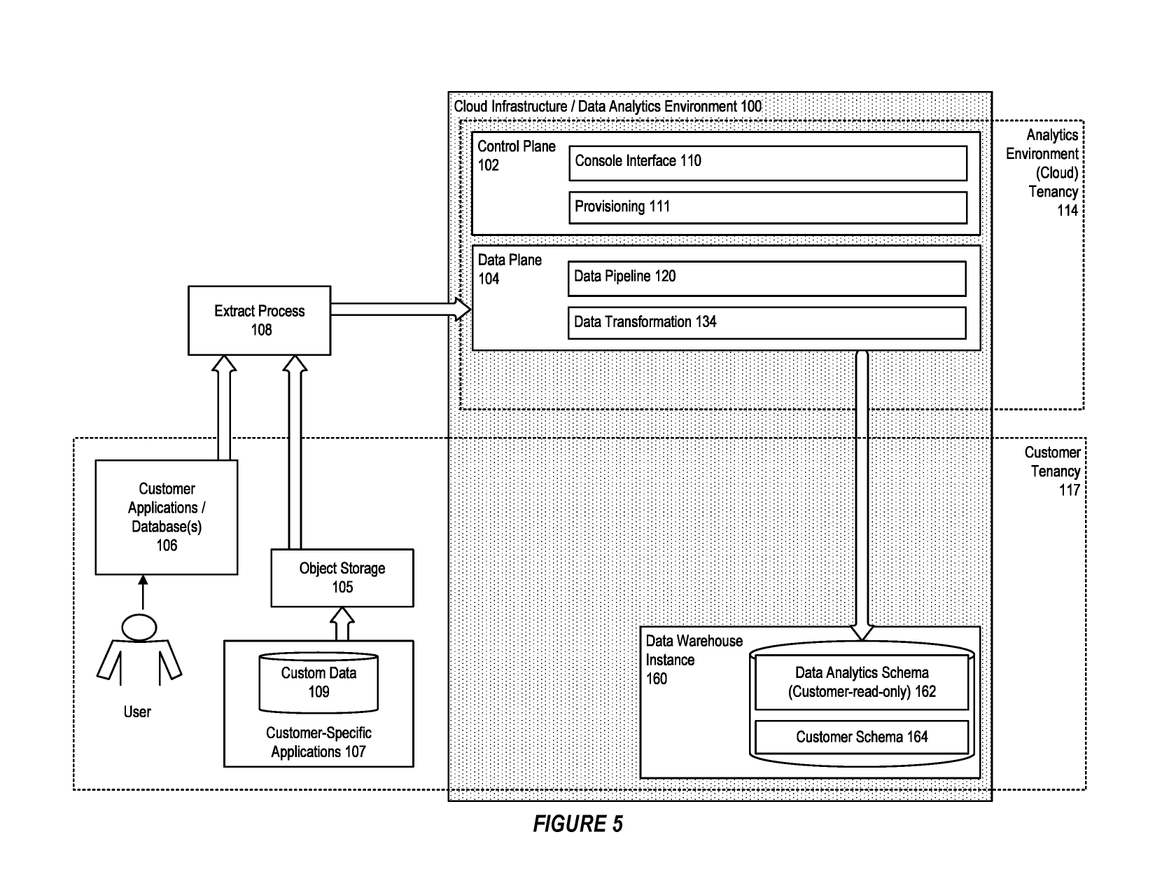

FIG. 5 further illustrates an example data analytics environment, in accordance with an embodiment.

As illustrated in FIG. 5, in accordance with an embodiment, data can be sourced, e.g., from a customer’s (tenant’s) enterprise software environment (106), using the data pipeline process; or as custom data 109 sourced from one or more customer-specific applications 107; and loaded to a data warehouse instance, including in some examples the use of an object storage 105 for storage of the data. A user can create a dataset that uses tables from different connections and schemas. The system uses the relationships defined between these tables to create relationships or joins in the dataset.

In accordance with an embodiment, the data warehouse can include a default data analytics schema 162 and, for each customer (tenant) of the system, a customer schema 164. For each customer (tenant), the system uses the data analytics schema that is maintained and updated by the system, within a system/cloud tenancy 114, to pre-populate a data warehouse instance for the customer, based on an analysis of the data within that customer’s enterprise applications environment, and within a customer tenancy 117. As such, the data analytics schema maintained by the system enables data to be retrieved, by the data pipeline or process, from the customer’s environment, and loaded to the customer’s data warehouse instance.

In accordance with an embodiment, the system also provides, for each customer of the environment, a customer schema that allows the customer to supplement and utilize the data within their own data warehouse instance. For each customer, their resultant data warehouse instance operates as a database whose contents are partly-controlled by the customer; and partly-controlled by the environment (system).

For example, in accordance with an embodiment, a data warehouse can include a data analytics schema and, for each customer/tenant, a customer schema sourced from their enterprise software environment. The data provisioned in a data warehouse tenancy is accessible only to that tenant; while at the same time allowing access to various, e.g., ETL-related, or other features of the shared environment.

In accordance with an embodiment, for a particular customer/tenant, upon extraction of their data, the data pipeline or process can insert the extracted data into a data staging area for the tenant, which can act as a temporary staging area for the extracted data. When the extract process has completed its extraction, the data transformation layer can be used to transform the extracted data into a model format to be loaded into the customer schema of the data warehouse.

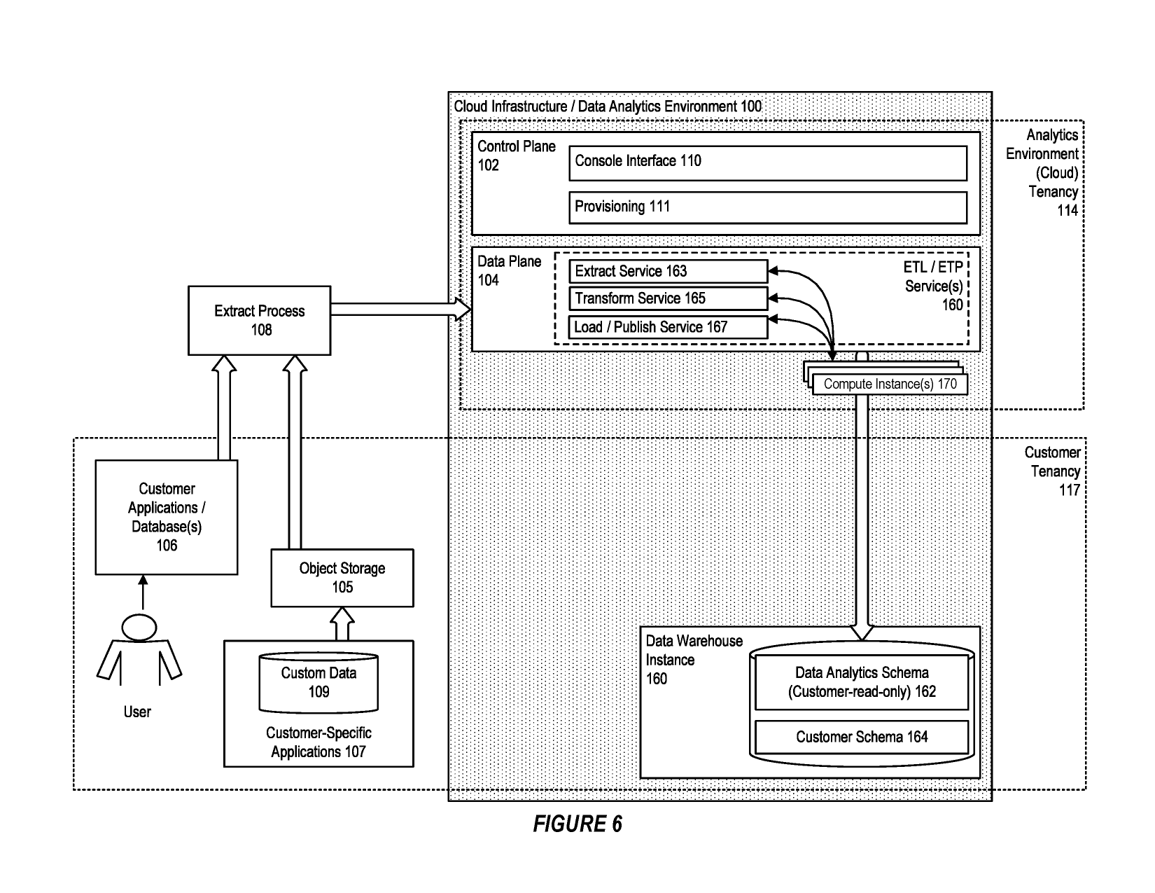

FIG. 6 further illustrates an example data analytics environment, in accordance with an embodiment.

As illustrated in FIG. 6, in accordance with an embodiment, the process of extracting data from a customer's (tenant's) enterprise software environment, and loading the data to a data warehouse instance, or refreshing the data in a data warehouse, generally involves several stages, performed by an ETL/ETP service 160 or process, including one or more extraction service 163; transformation service 165; and load/publish service 167, executed by one or more compute instance(s) 170.

For example, in accordance with an embodiment, extracted files can be uploaded to an object storage component for storage of the data. The transformation process then applies a business logic while loading them to a target data warehouse, e.g., an Autonomous Data Warehouse (ADW) database, which is internal to the data pipeline or process, and is not exposed to the customer (tenant). A load/publish service or process takes the data from the ADW database and publishes it to a data warehouse instance that is accessible to the customer (tenant).

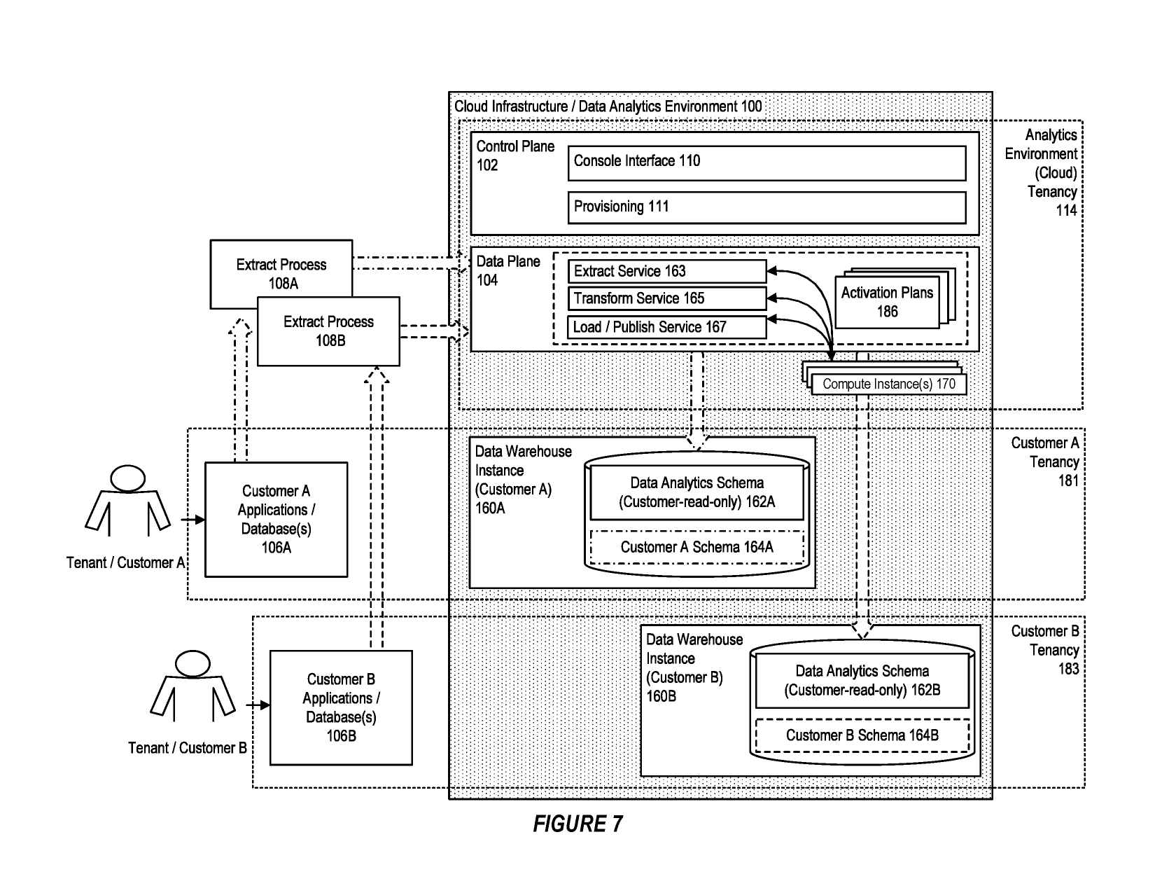

FIG. 7 further illustrates an example data analytics environment, in accordance with an embodiment.

As illustrated in FIG. 7, in accordance with an embodiment, the data pipeline or process maintains, for each of a plurality of customers (tenants), for example customer A 180, customer B 182, a data analytics schema that is updated on a periodic basis, by the system in accordance with best practices for a particular analytics use case. For each of a plurality of customers (e.g., customers A, B), the system uses the data analytics schema 162A, 162B, that is maintained and updated by the system, to pre-populate a data warehouse instance for the customer, based on an analysis of the data within that customer's enterprise applications environment 106A, 106B, and within each customer's tenancy (e.g., customer A tenancy 181, customer B tenancy 183); so that data is retrieved, by the data pipeline or process, from the customer's environment, and loaded to the customer's data warehouse instance 160A, 160B.

In accordance with an embodiment, the data analytics environment also provides, for each of a plurality of customers of the environment, a customer schema (e.g., customer A schema 164A, customer B schema 164B) that allows the customer to supplement and utilize the data within their own data warehouse instance.

As described above, in accordance with an embodiment, for each of a plurality of customers of the data analytics environment, their resultant data warehouse instance operates as a database whose contents are partly-controlled by the customer; and partly-controlled by the data analytics environment (system); including that their database appears pre-populated with appropriate data that has been retrieved from their enterprise applications environment to address various analytics use cases. When the extract process 108A, 108B for a particular customer has completed its extraction, the data transformation layer can be used to transform the extracted data into a model format to be loaded into the customer schema of the data warehouse.

In accordance with an embodiment, activation plans 186 can be used to control the operation of the data pipeline or process services for a customer, for a particular functional area, to address that customer's (tenant's) particular needs. For example, an activation plan can define a number of extract, transform, and load (publish) services or steps to be run in a certain order, at a certain time of day, and within a certain window of time.

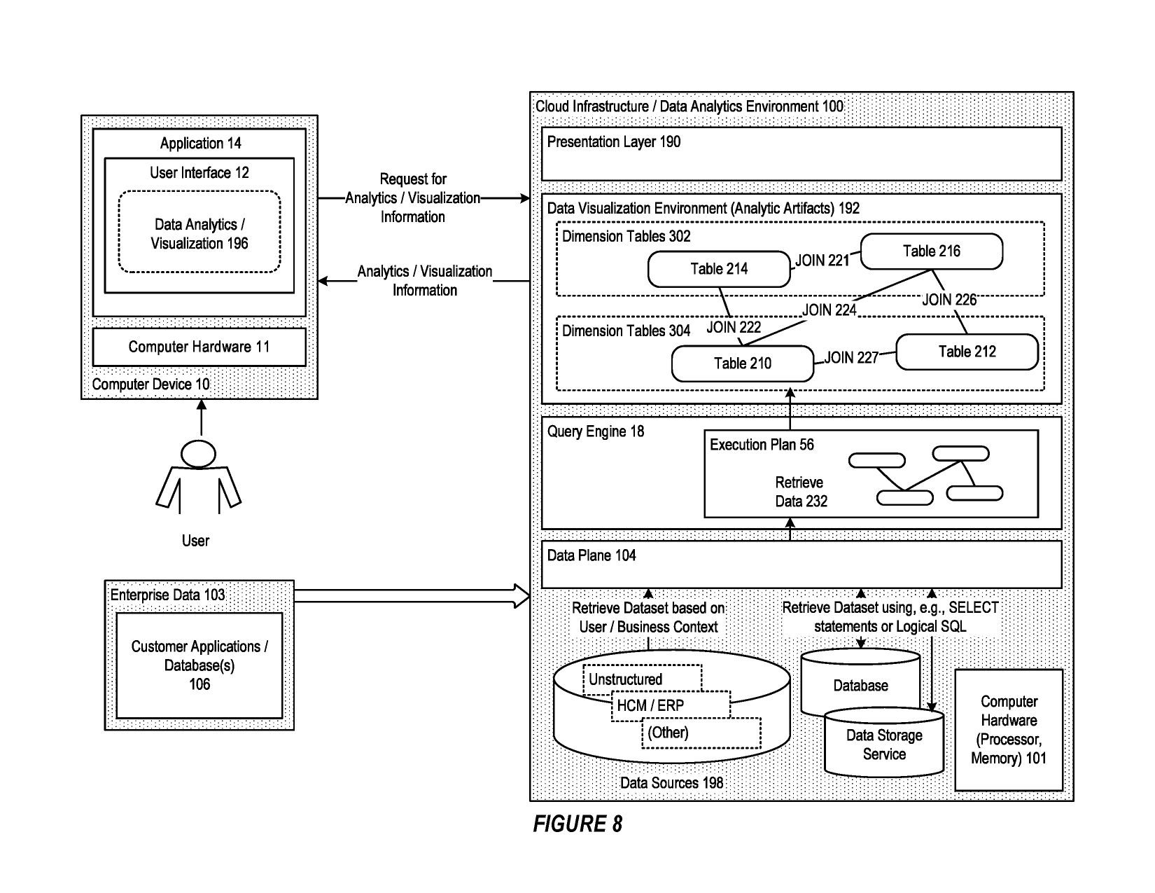

FIG. 8 further illustrates an example data analytics environment, in accordance with an embodiment.

Generally described, within a database or data warehouse, the data of interest may be spread across multiple tables. In such environments, joins can be used to stitch the data from various tables together, to better prepare the data for analysis.

For example, as illustrated in FIG. 8, in accordance with an embodiment, the data analytics environment enables a dataset to be retrieved, received, or prepared from one or more data source(s), for example via one or more data source connections, fact and/or dimension tables 210-216, or joins 221-227 between selections of dimension tables 302, 304.

In accordance with an embodiment, a request received at a data visualization environment to display analytic artifacts 192, for example as may be related to key performance indicators, analytics dashboards, or scorecards, can be received via a client application and user interface as described above, and communicated to the data analytics environment via a cloud service. The system can retrieve 232 an appropriate dataset using, e.g., SELECT statements, to address the user/business context, for use in generating and returning the requested data analytics or visualization information to the client.

### Machine Learning Environments

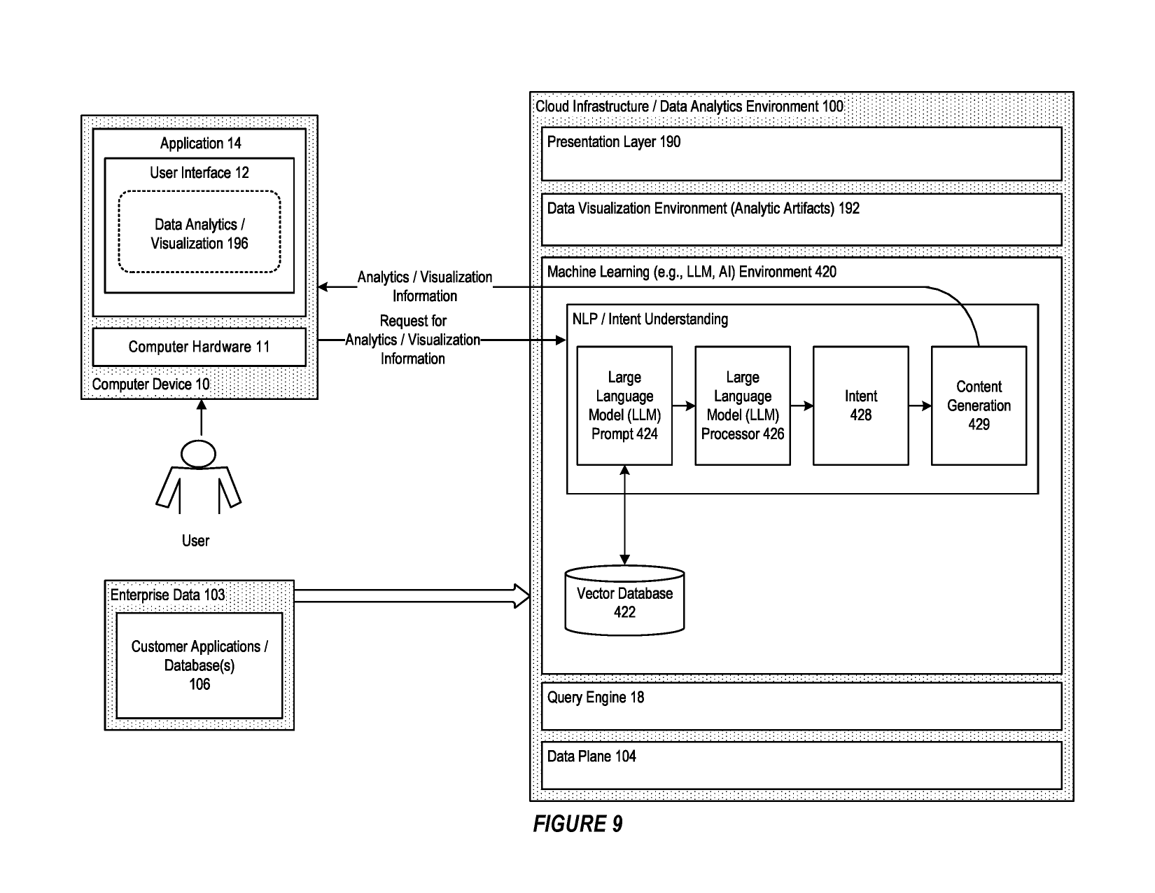

FIG. 9 further illustrates an example data analytics environment, including the use of a machine learning environment, for example a large language model, in accordance with an embodiment.

As illustrated in FIG. 9, in accordance with an embodiment, a data analytics system can include a machine learning (e.g., a large language model (LLM)) environment 420. A vector database 422 provides storage and retrieval of vectors or vector embeddings, which in turn enables LLMs to understand information with increased context and accuracy, for example in generating a requested data analytics information or data visualization.

In accordance with an embodiment, the system can parse a user query or request or natural language input, infer an intent 428 based on one or more meta prompts 424 or LLM processor 426, and then determine, for example, which subject areas may be relevant to the inferred intent, and generate or return an appropriate content 429.

### Retrieval-Augmented Generation RAG

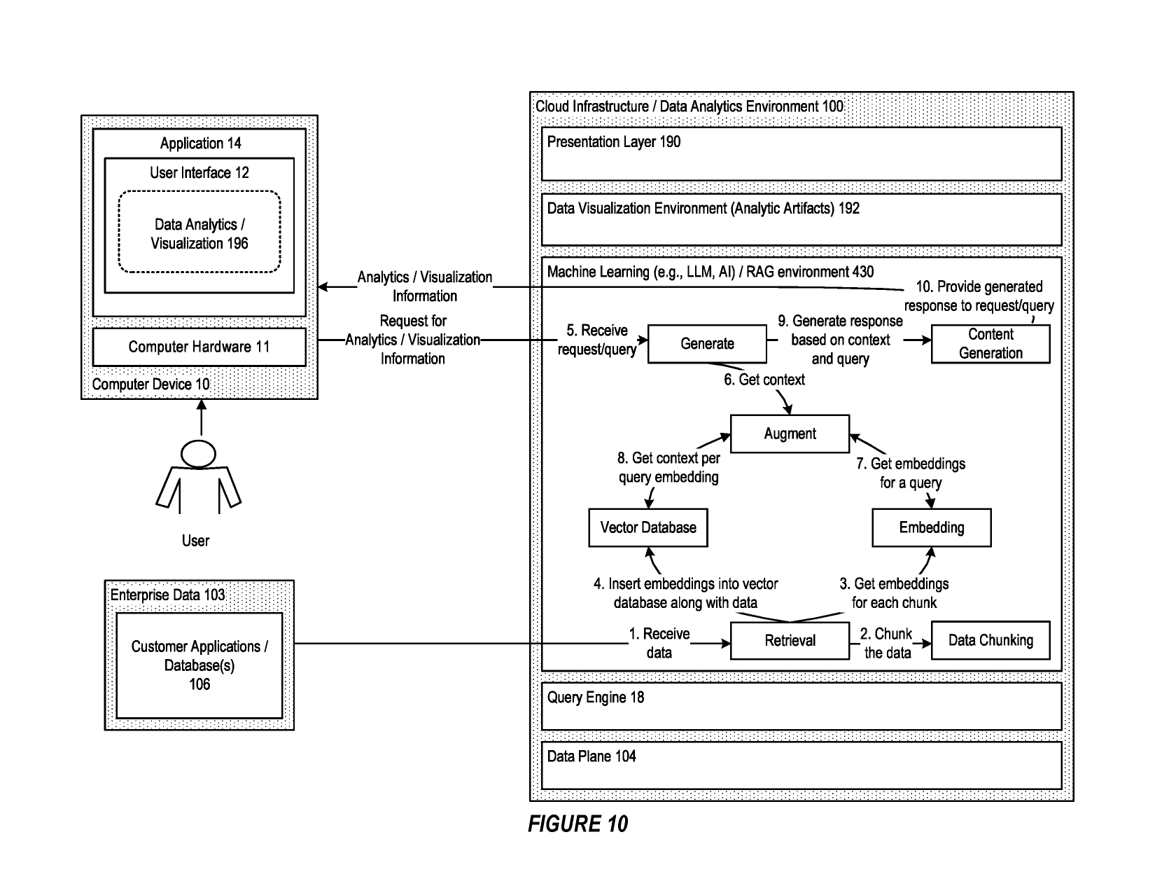

FIG. 10 further illustrates an example data analytics environment, including the use of a retrieval-augmented generation process, in accordance with an embodiment.

As illustrated in FIG. 10, in accordance with an embodiment, a data analytics system can include the use of a retrieval-augmented generation (RAG) environment 430 that optimizes the output of a machine learning model (e.g., an LLM) with targeted information, to provide a more contextually appropriate content in response to a user query or request.

In accordance with an embodiment, during the retrieval process:

Enterprise data can be received (1) in various formats, for example, as PDF, TXT, CSV, XML, or JSON documents, via REST, File, or other protocols.

The enterprise data or documents is broken into a plurality of segments or chunks (2).

Vector embeddings are obtained for each chunk of data (3), for example by calling a generative Al embedding service, or by using an embedding model.

The vector embeddings associated with the chunks of data are stored in a vector database, along with the data (4).

In accordance with an embodiment, during the augmented generation process:

The system can receive from a user, a data request or query, or a natural language input (5).

The system invokes an augmentation process or service to obtain the context for the request or query (6).

An embedding service is used to get the vector embeddings of the query data (7).

The augmentation process or service can obtain additional context based on a semantic search of the query data and its vector embedding (8).

The system can then generate an appropriate response based on the context and query (9); and return the generated response to the user (10).

The above example is provided for purposes of illustrating an example of a data analytics environment, that includes the use of retrieval-augmented generation. In accordance with other embodiments, the system can include other forms of retrieval-augmented generation, which in turn can include different or other components or processes.

### Support for Dataflows

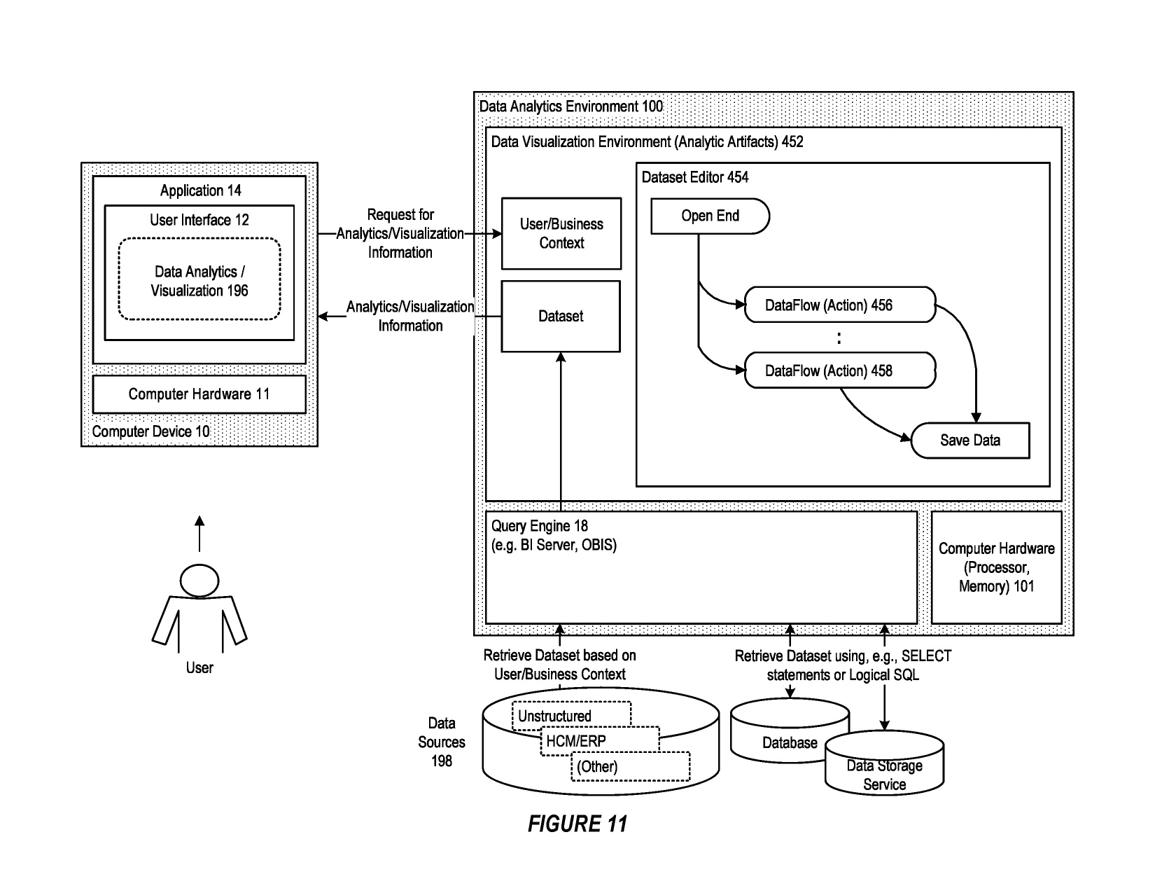

FIG. 11 illustrates a use of the system to transform, analyze, or visualize data, in accordance with an embodiment.

As illustrated in FIG. 11, in accordance with an embodiment, the systems and methods disclosed herein can be used to provide a data visualization environment 452 that enables insights for users of an analytics environment with regard to analytic artifacts and relationships among the same. A model can then be used to visualize relationships between such analytic artifacts via, e.g., a user interface, as a network chart or visualization of relationships and lineage between artifacts (e.g., User, Role, DV Project, Dataset, Connection, Dataflow, Sequence, ML Model, ML Script).

In accordance with an embodiment, a client application can be implemented as software or computer-readable program code executable by a computer system or processing device, and having a user interface, such as, for example, a software application user interface or a web browser interface. The client application can retrieve or access data via an Internet/HTTP or other type of network connection to the analytics system, or in the example of a cloud environment via a cloud service provided by the environment.

In accordance with an embodiment, the user interface can include or provide access to various dataflow action types, as described in further detail below, that enable self- service text analytics, including allowing a user to display a dataset, or interact with the user interface to transform, analyze, or visualize the data, for example to generate graphs, charts, or other types of data analytics or visualizations of dataflows.

In accordance with an embodiment, the analytics system enables a dataset to be retrieved, received, or prepared from one or more data source(s), for example via one or more data source connections. Examples of the types of data that can be transformed, analyzed, or visualized using the systems and methods described herein include HCM, HR, or ERP data, e- mail or text messages, or other of free-form or unstructured textual data provided at one or more of a database, data storage service, or other type of data repository or data source.

For example, in accordance with an embodiment, a request for data analytics or visualization information can be received via a client application and user interface as described above, and communicated to the analytics system (in the example of a cloud environment, via a cloud service). The system can retrieve an appropriate dataset to address the user/business context, for use in generating and returning the requested data analytics or visualization information to the client. For example, the data analytics system can retrieve a dataset using, e.g., SELECT statements or Logical SQL instructions.

In accordance with an embodiment, the system can create a model or dataflow that reflects an understanding of the dataflow or set of input data, by applying various algorithmic processes, to generate visualizations or other types of useful information associated with the data. The model or dataflow can be further modified within a dataset editor 454 by applying various processing or techniques to the dataflow or set of input data, including for example one or more dataflow actions 456, 458 or steps that operate on the dataflow or set of input data. A user can interact with the system via a user interface, to control the use of dataflow actions to generate data analytics, data visualizations, or other types of useful information associated with the data.

In accordance with an embodiment, datasets are self-service data models that a user can build for data visualization and analysis requirements. A dataset contains data source connection information, tables, and columns, data enrichments, and transformations. A user can use a dataset in multiple workbooks and in dataflows.

In accordance with an embodiment, when a user creates and builds a dataset, they can, for example: choose between many types of connections or spreadsheets; create datasets based on data from multiple tables in a database connection, an Oracle data source, or a local subject area; or create datasets based on data from tables in different connections and subject areas.

### Data Analytics Assistant with Digital Assistant Integration

In accordance with an embodiment, a data analytics system or environment can be integrated with a digital assistant which provides natural language processing capabilities, for purposes of leveraging the natural language processing of a user's text or speech input, within a data analytics or data visualization project, for example while generating, modifying, or interacting with data visualizations, or generating a story or script that includes or is descriptive of data visualizations.

For example, in accordance with an embodiment a data analytics system or environment, for example an Oracle Analytics Cloud (OAC) environment, can be integrated with a digital assistant system or environment, for example an Oracle Digital Assistant (ODA) environment, which provides natural language processing (NLP) and speech processing capabilities, for purposes of leveraging the natural language (NL) processing of a user's text or speech input, within a data analytics or data visualization project, for example while generating, modifying, or interacting with data visualizations.

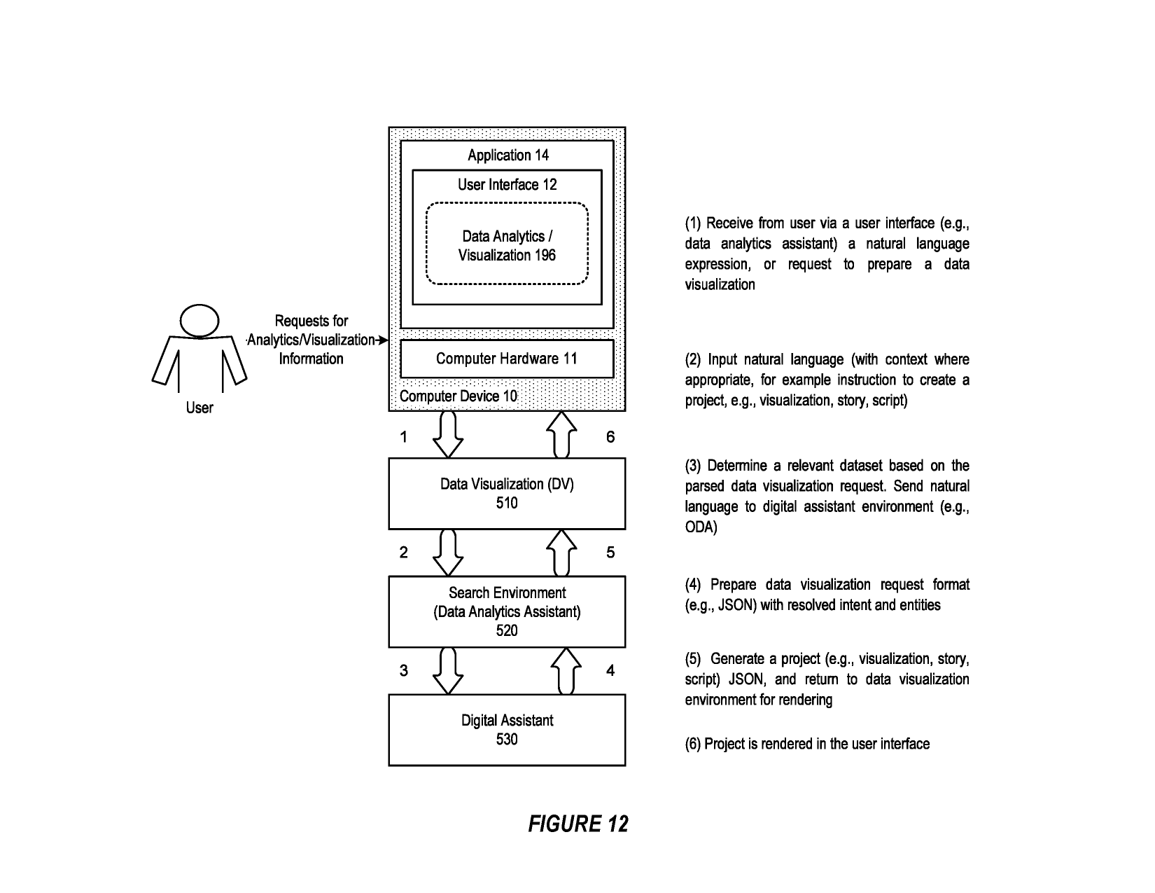

FIG. 12 illustrates a system for providing digital assistant integration with a data analytics assistant, in accordance with an embodiment.

As illustrated in FIG. 12, in accordance with an embodiment, at (1) a data analytics system or environment, for example an Oracle Analytics Cloud (OAC) environment, receives as input from a user via a user interface (e.g., data analytics assistant) a natural language expression, or request to prepare a data visualization 510.

At (2), the input natural language can be associated with a context where appropriate, for example an instruction to create a project, e.g., visualization, story, script.

At (3), a relevant dataset can be determined by a search component 520 (e.g., Ask, BI Search) based on the parsed data visualization request (context supplied with input and/or based on keywords in input). Based upon the determination of the relevant dataset, the natural language input can be sent to a digital assistant environment 530 which provides natural language processing (NLP) and speech processing capabilities, for purposes of leveraging the natural language (NL) processing of the natural language expression, e.g., a user's text or speech input.

At (4), a data visualization request format (e.g., JavaScript Object Notation, JSON) can be prepared with resolved intent and entities.

At (5), the JSON data prepared with resolved intent and entities is returned to the data visualization (DV) environment for rendering.

At (6), the data analytics or data visualization project is rendered in the user interface (UI).

### Natural Language Input

In accordance with an embodiment, a natural language generator (NLG) service within OAC can generate simple and insightful natural language text for a given visualization. A straightforward text explains the data behind the visualization, whereas an insightful text is meant to provide related but useful insights about the columns and the data surrounding them in the visualization. The data analytics assistant can then use the insights text generation feature to fetch and display related insights for the visualization.

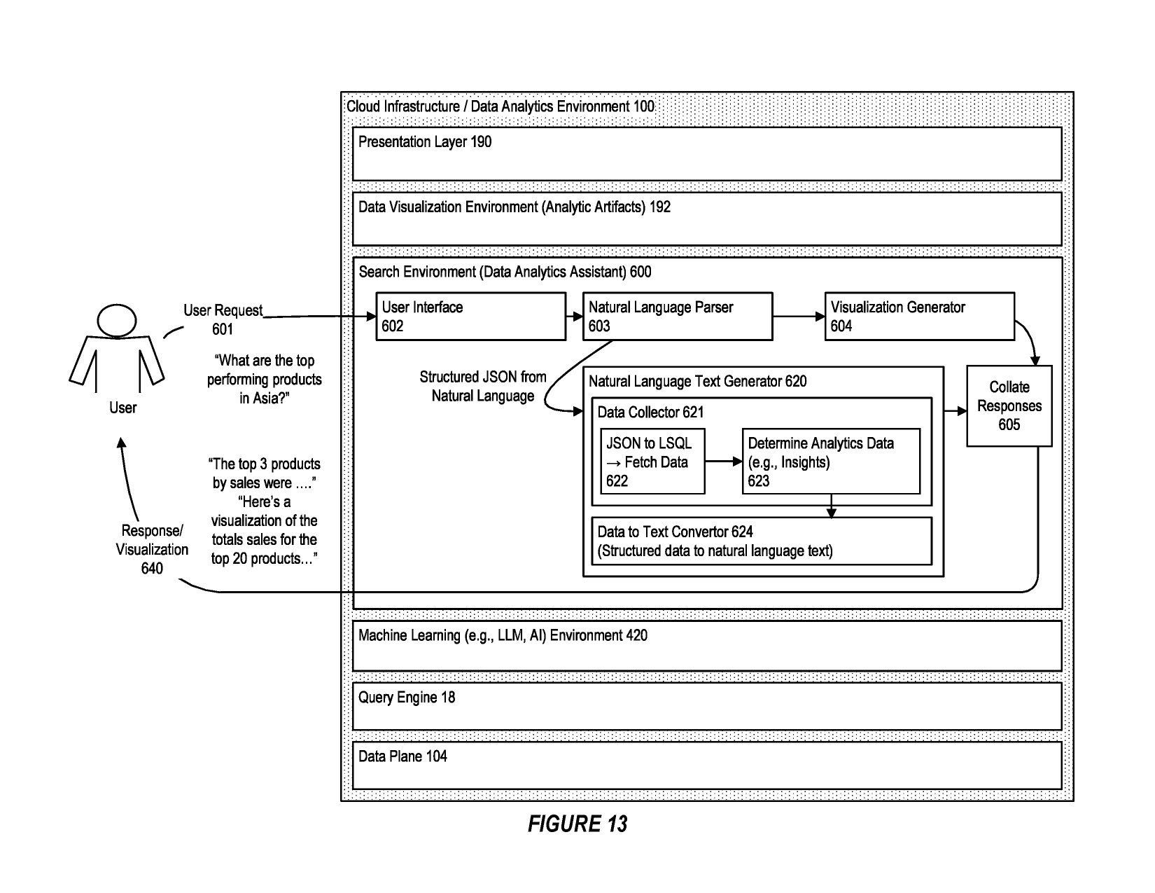

FIG. 13 illustrates the use of a natural language generator service to support digital assistant integration, in accordance with an embodiment.

As illustrated in FIG. 13, in accordance with an embodiment, a user can interact with a user interface 602 of a search environment 600 (e.g., Ask, BI Search) via a natural language utterance/input. A request 601 can be passed to a natural language parser 603 and parsed for use by a visualization generator 604 and natural language text generator 620 comprising a data collector 621 and data to text converter 624. Responses (for example, JSON- to-SQL operations to fetch data 622, or determine analytics data such as insights 623) can be collated 605 in order to provide a response/visualization 640 to the user interface.

In accordance with an embodiment, as used with the overall data analytics assistant feature, the natural language generator service can include a data collector responsible for generating the insightful data for a given visualization. To accomplish this, it takes the visualization metadata as input. The metadata is processed to extract an input grammar for the NLG service. For example, the input grammar is made up of the projections, group by and filter expressions, dimension and measure columns and any other aspects of the visualization that can be of potential use in generating insights data.

In accordance with an embodiment, the input grammar is pruned using the dataset profile to generate insights grammar. The process of pruning applies transforms to generate insights grammar. For example, one of the transformations is to determine a dimension column either from the input grammar or the dataset to explain the measure in the input visualization. Based on this, a rank filter predicate is added to the grammar. This is just one example of the transformation that aids in fetching a top N insights. The final step is to convert the insights grammar into a logical SQL (LSQL) that can be executed to fetch insights data.

For example, as illustrated in FIG. 13, in accordance with an embodiment, a user request received at the user interface, such as for example "What are the top performing products in Asia?" is parsed by a natural language parser and passed to a visualization generator. A natural language text generator can then be used to generate a response associated with a visualization, such as for example "The top 3 products by sales were ... Here's a visualization of the totals sales for the top 20 products ...".

### Provider Framework

In accordance with an embodiment, the system supports a user's chat-like conversations utilizing a semantic search based provider framework. The provider framework provides a flexible approach to having chat conversations, as opposed to the limited scope of flowchart based alternatives.

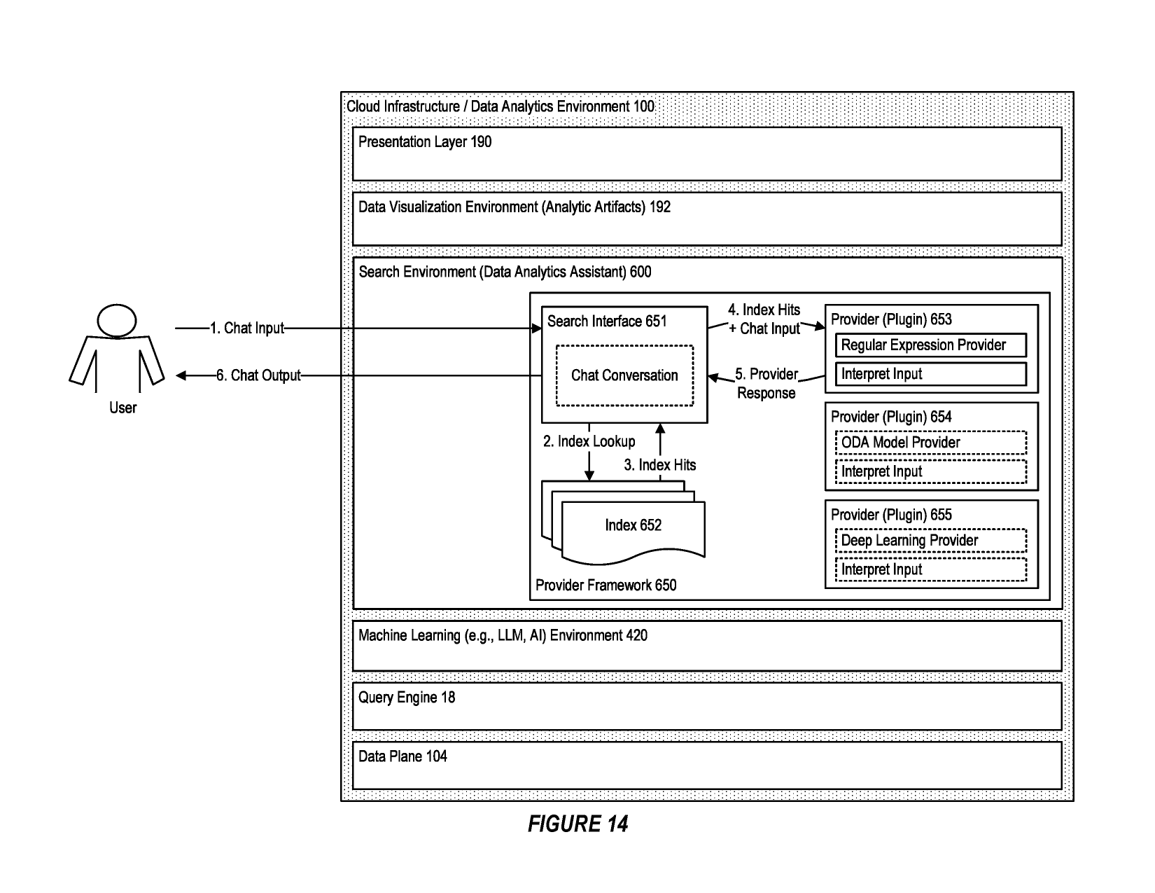

FIG. 14 illustrates the use of a provider framework 650 to support digital assistant integration, in accordance with an embodiment.

In accordance with an embodiment, a search environment or search interface 651, such as Ask, supports chat-like interactions for a given dataset with measure and dimension columns. The scope is not limited to datasets but can expand to include any artifact within the search or data analytics environment.

In accordance with an embodiment, an index 652 operates as a repository of documents, with each document containing fields that describe the various facets of a single item in a system catalog. The index can contain the items in the search or data analytics environment (including datasets) thereby acting as a global dictionary, and can be seeded with additional metadata/keywords that provide contextual support for processing a user's utterance or chat input.

In accordance with an embodiment, in order for synonyms to provide the ability to express in natural language, the system can be adapted to understand synonyms for words. Synonym information can be pre-seeded into the system via a knowledgebase, or can be curated by the user community.

In accordance with an embodiment, the provider framework operates as an abstraction over various implementations of the provider.

In accordance with an embodiment, a selected provider (i.e., selected from a number of optional providers 653, 654, 655) operates as an implementation of the provider framework to interpret a user's utterance or chat input along with the hits from the index. Such providers can leverage as simple as a regular expression interpretation of the user's utterance or chat input, or as complex as a large language model.

For example, in accordance with an embodiment, a regular expression (regex) provider leverages regular expressions to match a given utterance or chat input against a set of given rules, and extracts parts of the input.

The extracted parts can then be evaluated against index lookup terms passed to the provider, thereby effectively resolving valid column names (including synonyms) of a dataset and ignore invalid ones.

The index provides support to determine a column name for a column value specified in the user's utterance or chat input, even if the column name itself is not present in the utterance. The chart type specified in the input can also be inferred from the index.

This technique enables effective resolution of the utterance or chat input to generate an appropriate response. The ability to combine metadata (including synonyms, chart types) from the index along with sets rules of regular expression make this a powerful technique for chat input resolution and response. This can be made more natural to the user if the user interface elements based on user selection generates an utterance or chat input which potentially matches one of the regular expression rules.

In accordance with an embodiment, the provider framework includes a model provider backed by a model that supports handling expressive forms of utterance in chat. The model can be created for a dataset by using, e.g., in an OAC environment an ODA API to create a skill, creating a schema for the dataset within the skill, and subsequently training the skill which builds a model associated with the skill. When trained, the skill can then handle utterance or chat inputs that are directed to that provider.

In accordance with an embodiment, a deep learning model provider (e.g., provider plugin) can be backed by a large language model (LLM) thus enabling handling of more expressive/colloquial forms of utterance in chat. The LLM itself can be any model, including, for example, any of the available open source models.

### LLM-Assisted Assessment of User Input

Some approaches to natural-language-driven data analytics require that specific forms of natural language questions be set up within the system in advance, which a user can then select from or invoke to obtain various answers.

In other systems that support the use of language models to analyze data files, a user may be required to provide particular data files and then explicitly request the language model to answer specific questions, for example to identify particular data trends associated with those files.

Such approaches and systems generally lack the flexibility to accommodate new sources of data, or free-flowing question-and-answer forms of interaction or data analysis.

Embodiments described herein are generally related to computer data analytics, and computer-based methods of providing analytics data, and are particularly directed to providing a data analytics assistant that includes the use of an LLM in assessing and responding to user input.

In accordance with an embodiment, the system includes an LLM-assisted user input assessment component and user interface that allows the user to enter a user input in the form of a natural language query or request.

In response to said user input, the system operates to Find, by reference to a vector database or vector store, data assets with an affinity to the original, e.g., query or request, based on their vector similarity; determine, based on processing of the query or request by an LLM, an intent associated therewith; tune, augment, or otherwise adjust based on found data assets and responses received from the LLM, the query or request for use in addressing the determined intent; and route the LLM-augmented query or request for subsequent handling, for example to query a dataset or provide a data analytics or visualization.

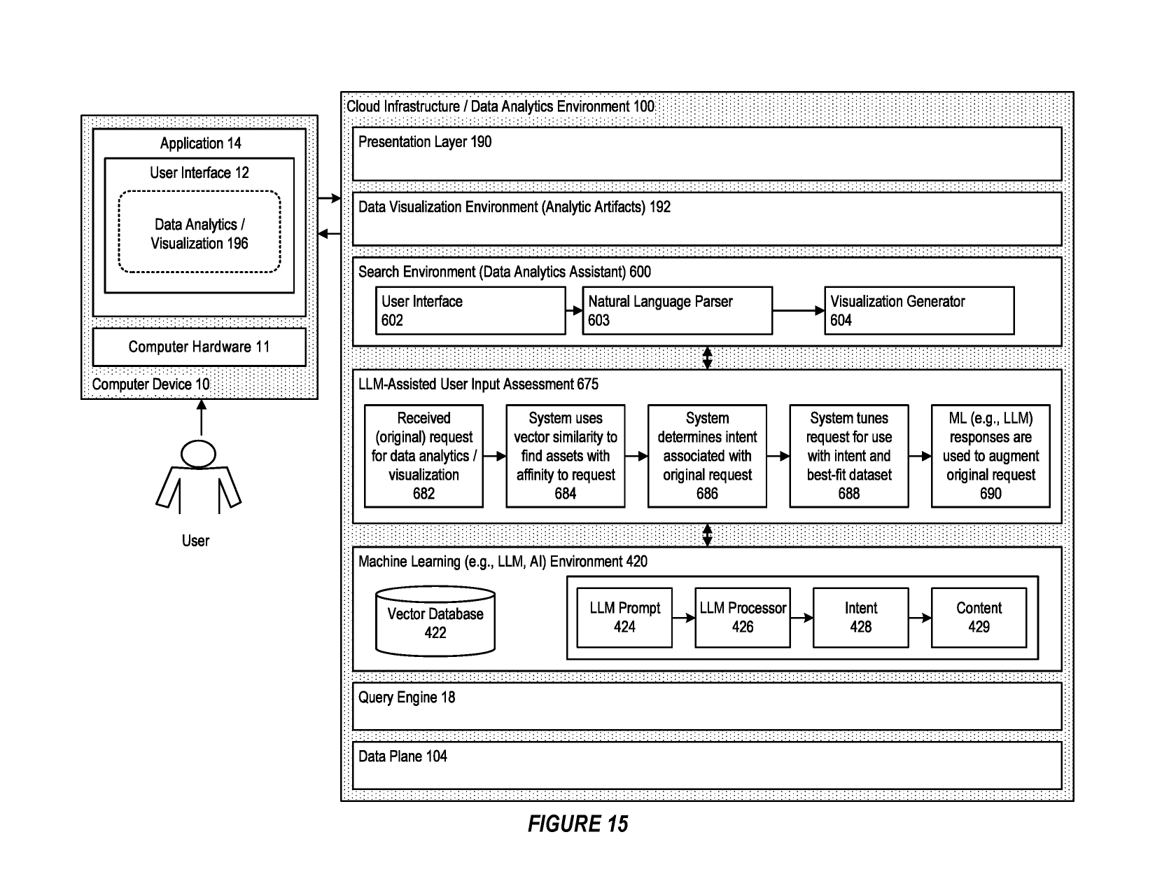

FIGS. 15-21 illustrate the use of a large language model (LLM) in assessing user input, in accordance with an embodiment.

In accordance with an embodiment, the system can incorporate the use of a large language model (LLM) in the manner of a front-end mechanism to a digital assistant or data analytics user interface, to assess a user's natural language input and determine an associated intent, based on semantic similarity with available data assets, such as data catalogs or datasets.

As illustrated in FIG. 15, in accordance with an embodiment, the system includes an LLM-Assisted User Input Assessment component 675, whereby the system performs operations that include receiving an (original) request for data analytics / visualization 682; using vector similarity to find assets with affinity to the request 684; determining an intent associated with the original request 686; tuning the request for use with the intent and a best-fit dataset 688; and using machine learning (e.g., LLM) responses to augment the original request 690

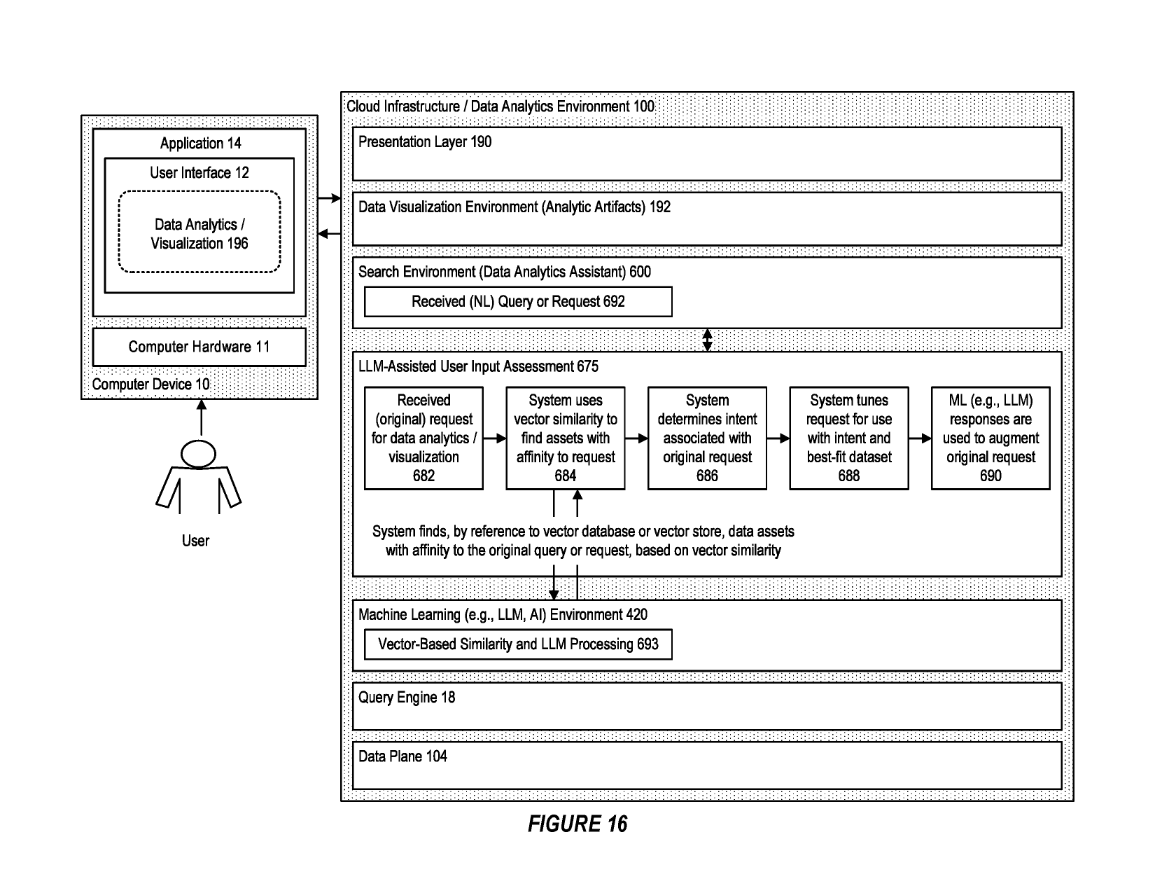

As illustrated in FIG. 16, in accordance with an embodiment, in response to user input, for example, a received natural language (NL) query or request 692, the system operates with a machine learning (e.g., large language model, LLM) environment that provides vector- based similarity and LLM processing 693, to find, by reference to a vector database or vector store, data assets, for example data catalogs or datasets, with an affinity to the original, e.g., query or request, based on their vector similarity.

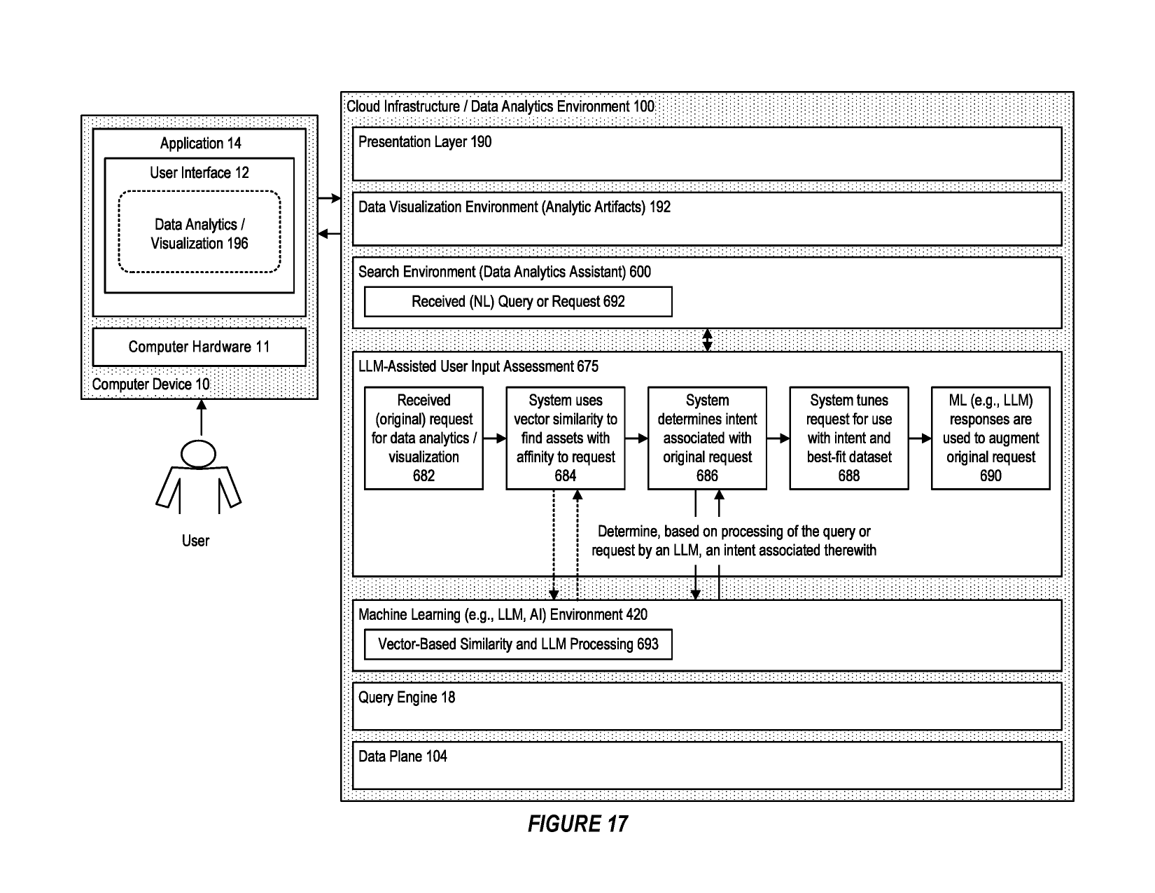

As illustrated in FIG. 17, in accordance with an embodiment, the system operates to determine, based on processing of the query or request by an LLM, an intent associated therewith, for example to create a workbook or dashboard.

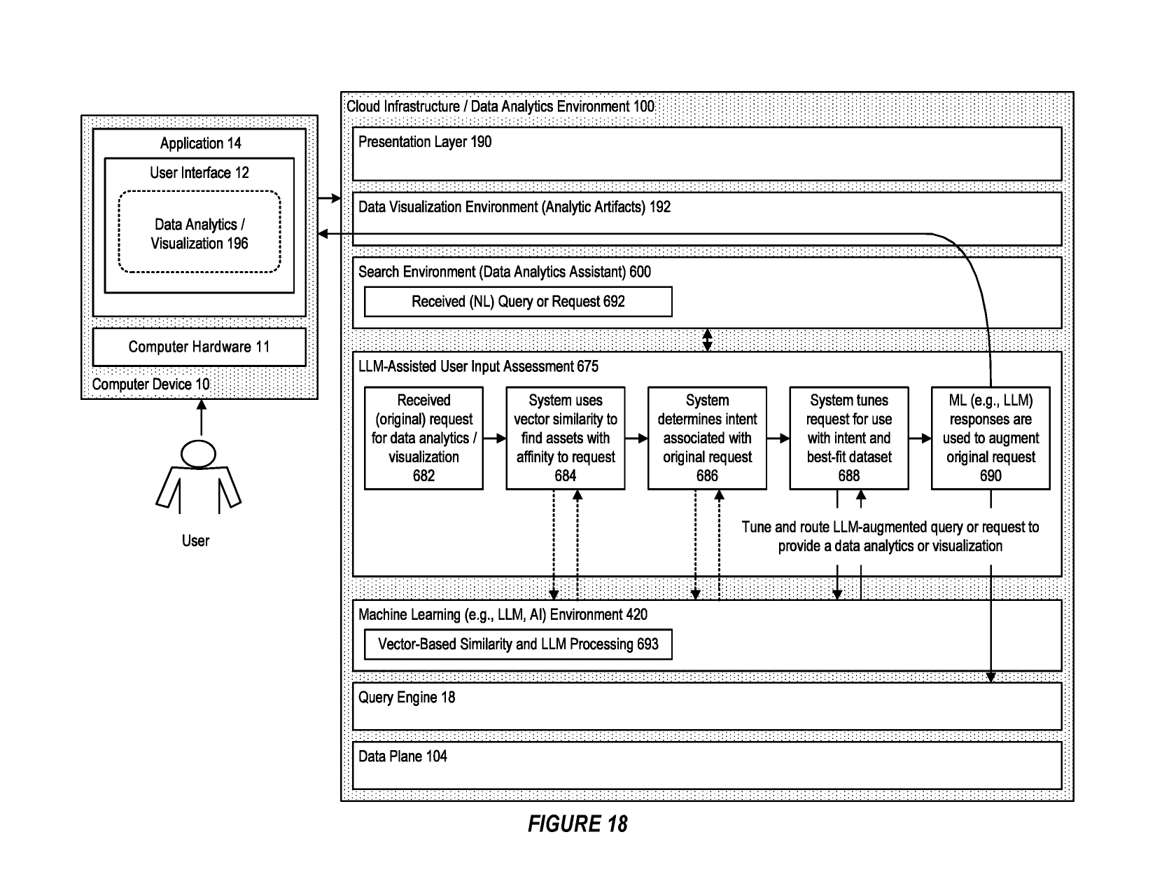

As illustrated in FIG. 18, in accordance with an embodiment, the system operates to Tune, based on found data assets and responses received from the LLM, the query or request for use in addressing the determined intent and a best-fit, e.g., dataset, and route the LLM-augmented query or request for subsequent handling, for example to query the dataset and provide a data analytics or visualization to the user interface.

In accordance with an embodiment, each of the data catalogs, datasets, descriptions, example questions, and user input can be vectorized, for use assessing vector similarity. The user's natural language input can be vectorized and compared with a vector database associated with the customer data, to determine, based on vector similarity, appropriate matches for the intent, for example data catalogs or datasets, and return appropriate results.

Since a user's natural language input can be assessed based on vector similarity, appropriate matches can be returned, even if the specific terms used in a dataset description are not specifically indicated in the original user input. If upon assessing a user input, a particular data catalog or dataset does not include an explicitly-defined description, the system can automatically generate a description - effectively allowing a data catalog or dataset to be self- describing.

In accordance with an embodiment, the user's natural language input (e.g., their original question) that is sent to the LLM does not include actual data retrieved from the customer's database. The LLM is used only as a means of understanding the intent within the user's original question or natural language input. For example, in accordance with an embodiment, the LLM is provide with a metadata descriptive of the original request, and likewise returns a metadata which can be used by the system to determine a context or further understand the query or request and provide the context or understanding to, e.g., a query engine for further processing.

For example, in accordance with an embodiment, the LLM can be used to augment a question such as "Show me sales in the capital of Texas: - in which case the LLM can determine that Austin is the capital of Texas, and provide this context or understanding as metadata to the system for use in generating a modified question that includes this information, i.e., that the capital of Texas being Austin, which can then be passed along with the original request to a query engine for further processing.

In accordance with an embodiment, the information provided by the LLM can then be used with the customer's database, or with additional data sources that are registered via a connection to the data analytics environment. Data can be retrieved from internal datasets, or from external data sources if appropriate, to find a dataset that has a high affinity or is closely correlated to the question. External data sources can be registered and used within the system using a connection, including for example, a connection to Fusion Applications or other environment that provides, e.g., HCM, SCM, or other enterprise data.

In accordance with an embodiment, the system can present a user interface that allows the user to enter questions, or other natural language input; determine if the user input is intended, for example, as being directed to one or more target data catalogs or datasets; and process the input accordingly, for example to search for or within a particular dataset; create a dashboard or data visualization; open a data analytics workbook; or search for some information in a registered database.

For example, in accordance with an embodiment, in response to a user input to the system to generate a chart, the system can use one or more LLMs to generate an interaction with the user, locate or find a dataset that has a high affinity to the user input, and tune or augment the user input for use with the dataset so that the resulting query is best directed to an appropriate dataset or associated metric. The user input (e.g., question, or request) as tuned, augmented, or otherwise adjusted, can then be processed directly by the data analytics assistant (e.g., as may be provided within an Oracle Analytics Cloud (OAC) or other data analytics environment) or provided to a query engine for further processing.

In accordance with an embodiment, the system can utilize either one or multiple LLMs, for example, a first LLM to determine an intent, and then another LLM to tune or augment the query or request, based on found data assets and responses received from the LLM, and then yet another LLM to generative a narrative for the generated charts, or to generate a podcast for the narrative. The system can include the use of multiple LLMs to process a particular user input, depending on the path the user input takes.

In accordance with an embodiment, the system can automatically generate in real- time or on-the-fly a story, podcast, or other form of audio or video output which will narrate the system-generated recommendation or narrative information. For example, in accordance with an embodiment, the described approach can be used to generate a video output with the narration synchronized with a dashboard presentation by leveraging the functionality of a closed-captioning system and encoding in the closed-captioning text time-coded elements that relate back to the dashboard.

In accordance with an embodiment, a user can select from within particular users, personalities, or voices, for purpose of generating the audio narration. Using closed-captioning techniques, the audio narration can be synchronized with a dashboard or data visualizations, so that as the audio narration plays the corresponding visualization is also highlighted. This also allows the user to navigate back-and-forth between the audio narration and the visualization.

In accordance with an embodiment, the system operates to received user inputs, and provides responses in a natural language format, similar to having a dialog or conversation with the computer. As each chart is displayed, the user can interact further with the system.

For example, in accordance with an embodiment, the system can utilize a natural language generator service to allow a user to ask the system to explain what they are seeing in a particular chart . For example, the user can ask the system to explain or provide analytics related information about the chart, or switch to a new topic for example by asking "create a new dashboard: then the system updates the search and continues with the new dashboard.

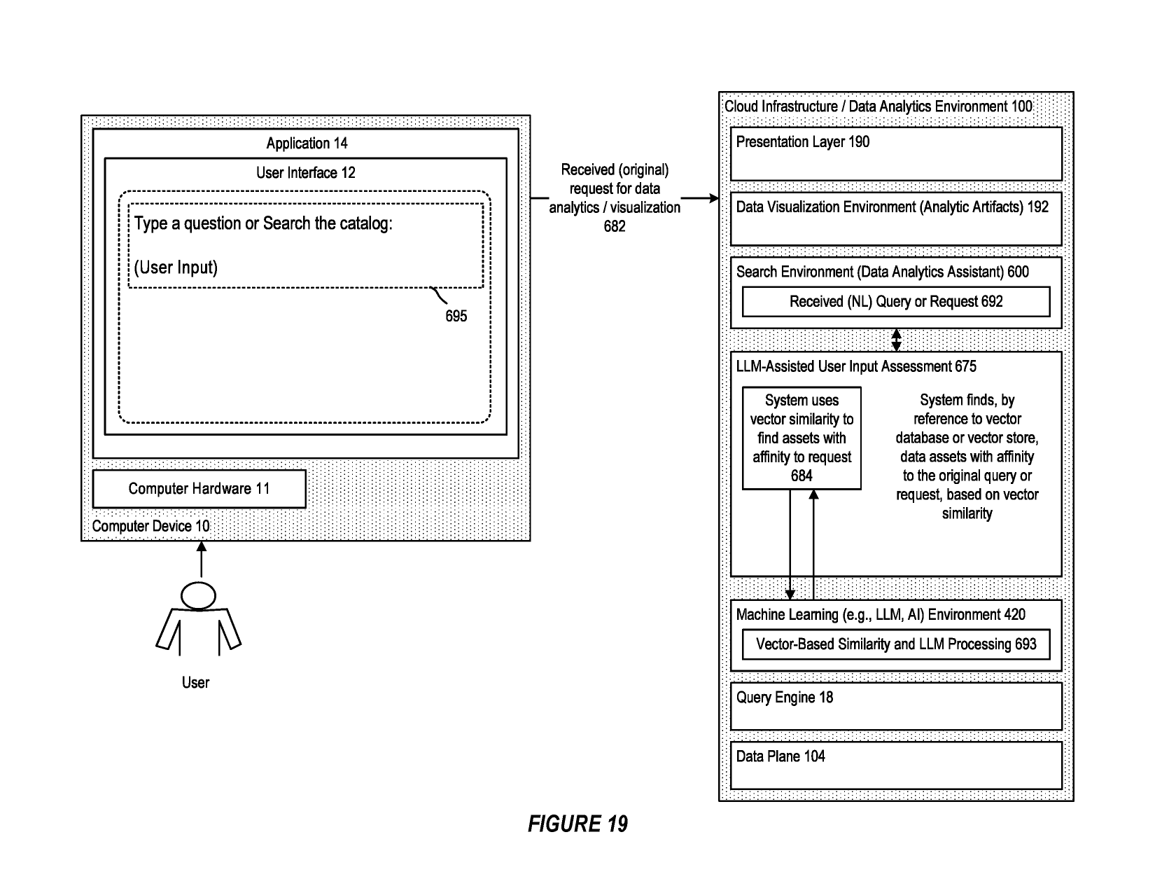

As illustrated in FIG. 19, in accordance with an embodiment, the LLM-assisted user input assessment component can be used to provide a user interface that prompts the user to, for example "Type a question or Search the catalog" (695), and allows the user to enter a user input in the form of a natural language query or request, such as "Do I have any recent workbooks about climate change?"

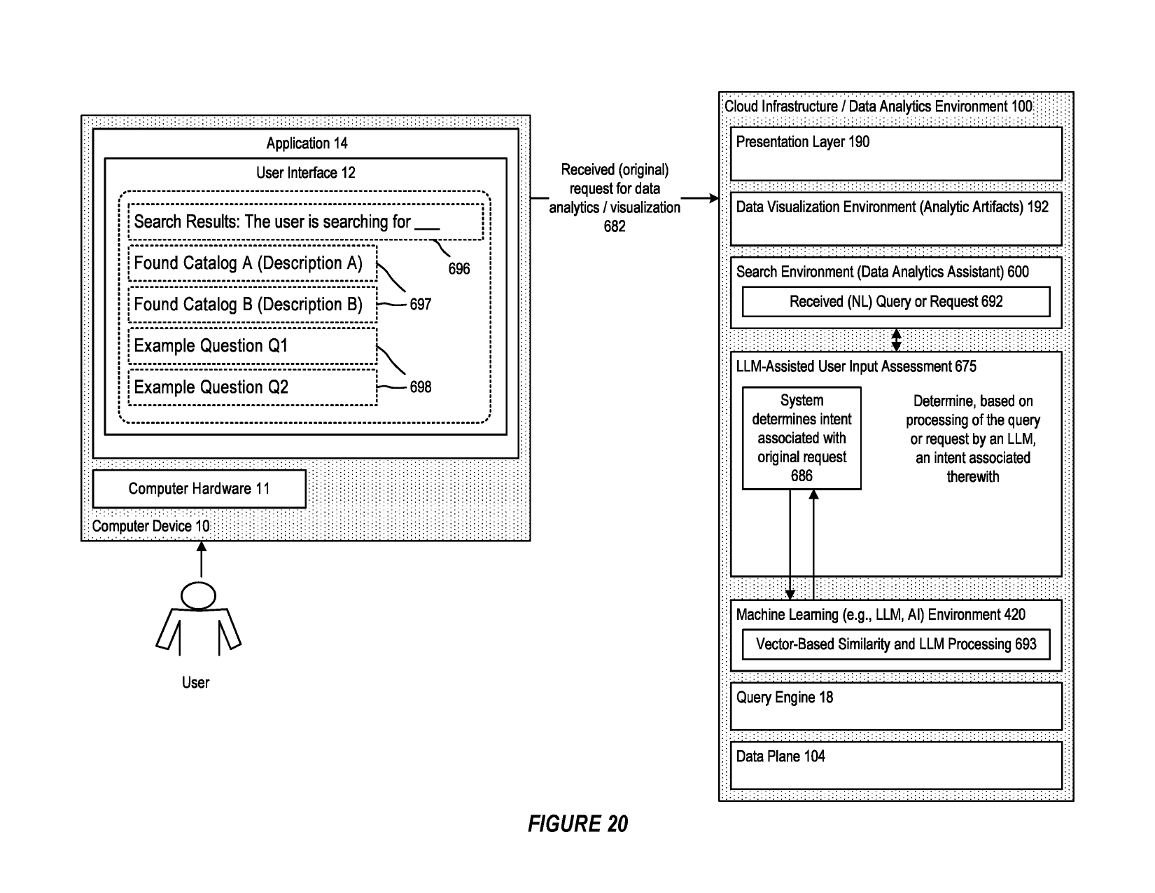

As illustrated in FIG. 20, In accordance with an embodiment, if upon assessing a user input (696), a particular data catalog or dataset does not include an explicitly-defined description, the system can automatically generate a description (697) - effectively allowing a data catalog or dataset to be self-describing.

In accordance with an embodiment, when the system generates a description for the data catalog or dataset it can also generate a set of example questions (698) which that information, for example, the columns and rows of data in the dataset, could be used to answer (700). The information produced can be stored in the vector database, or a vector store, for subsequent use in determining, e.g., data catalogs or datasets that are semantically relevant to a received user input. The system can highlight one or more most relevant items in the catalog in reference to a received user input, and provide recommendations or narratives associated with the results.

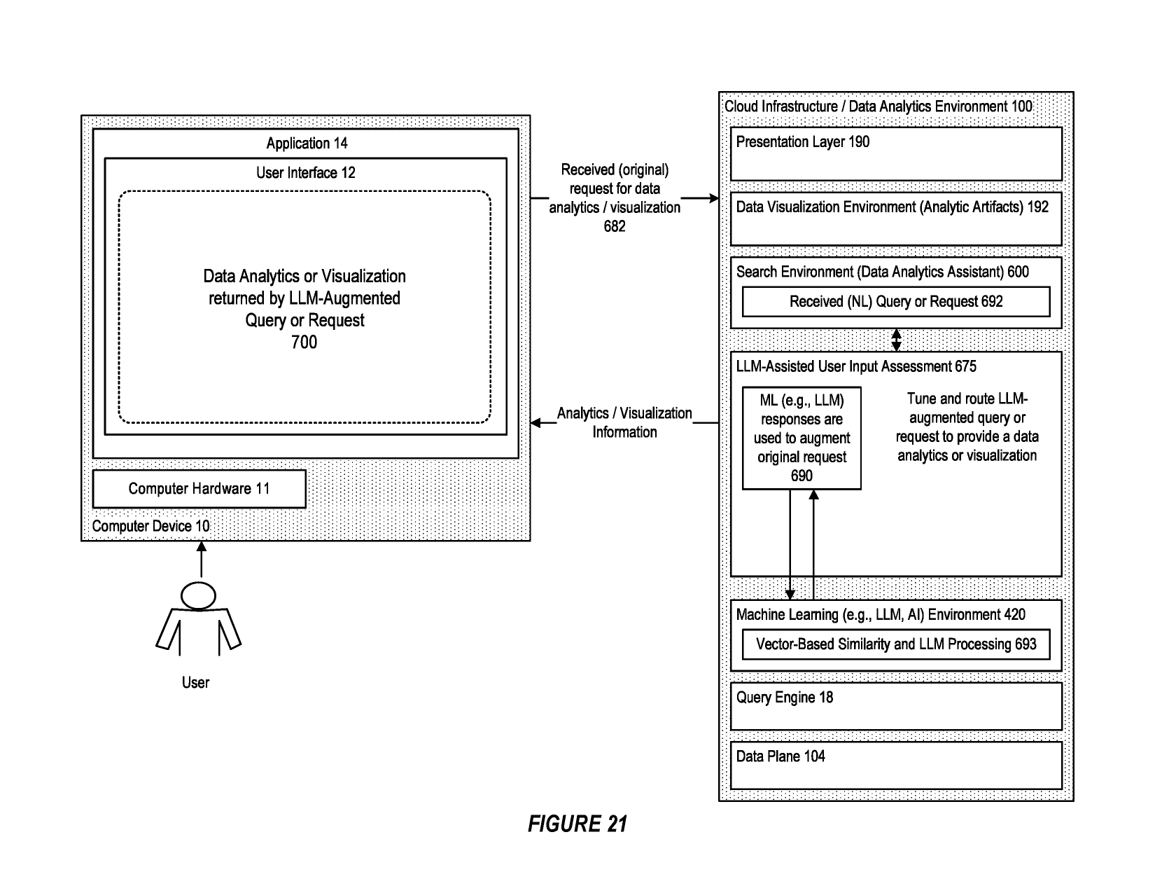

As illustrated in FIG. 21, In accordance with an embodiment, the computer operates to Route the LLM-augmented user input or request for subsequent handling, for example to query a dataset or provide a data analytics or visualization.

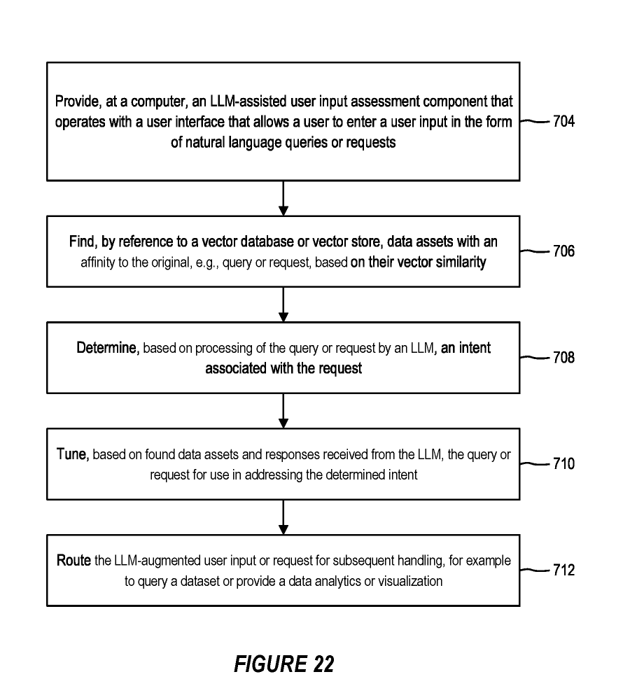

FIG. 22 illustrates a method for use of a large language model (LLM) in assessing user input, in accordance with an embodiment.

As illustrated in FIG. 22, in accordance with an embodiment, at step 704, a computer provides an LLM-assisted user input assessment component that operates with a user interface that allows a user to enter a user input in the form of a natural language query or request.

At step 706, In response to said user input, the computer operates to Find, by reference to a vector database or vector store, data assets with an affinity to the original, e.g., query or request, based on their vector similarity.

At step 708, the computer operates to Determine, based on processing of the query or request by an LLM, an intent associated therewith.

At step 710, the computer operates to Tune, based on found data assets and responses received from the LLM, the query or request for use in addressing the determined intent.

At step 712 the computer operates to Route the LLM-augmented user input or request for subsequent handling, for example to query a dataset or provide a data analytics or visualization.

### Interaction-Directed Analytics

In accordance with an embodiment, the system can include a means of providing interaction-directed analytics information, for use with data analytics environments. In accordance with an embodiment, the system can leverage a real-time transcription of an interaction between one or more users, for example as part of a conversation, in combination with a large language model or knowledge service, to drive the surfacing of relevant data visualizations or other analytics information.

Generally, with other approaches to language-driven analytics, when a user needs specific data to answer questions they must use a tool or process to setup or configure specific questions that can be used to receive an answer. Even when prompting a large language model (LLM) to analyze a data file, the user must provide the file and then explicitly request the LLM to identify either automatically-identified trends or answer specific questions.

In accordance with an embodiment, the described approach makes this process more automatic via interaction-directed analytics. The system can surface relevant data points and analytic results to implied questions based on a stream of language or interactions. The system reads a stream of voice or text input (such as speech or a transcription of speech), processes it to identify data and data comparison related words or keywords and concepts, and then associates these words as a natural language query, finally outputting a query and calculations representing the context.

In accordance with an embodiment, the data related words can be identified based on natural language by associating word to semantic types from a knowledge service. For example, if a user says "the total sales," the tool can identify data elements across datasets which have that meaning such as "revenue" or "amount of sales".

In accordance with an embodiment, then the type of query generated and chart to create can be based on an auto-insights service which uses heuristics to determine useful query/chart types for different comparison or observation concepts. For example, rate analysis can be visualized over time, while comparisons between numbers by dimensions can be visualized via scatter plots.

In accordance with an embodiment, the system maintains a self-created, ordered context out of these identified data key words and the data created in graphs to allow interpretation of relative phrases such as "what was the maximum" or "what was it last year. " This maps to a natural discussion where people can refer back to elements of the shared conversation context without explicitly saying the full name of the item referenced.

Additionally, in accordance with an embodiment, the system can add references or gestures to created analysis data as additional context such as "picking a chart" increase the weight and relevance of data keywords and calculations to future queries.

In accordance with an embodiment, the system can be used to generate a story or script that includes or is descriptive of data visualizations. For example, in accordance with an embodiment, the data analytics assistant can operate in the manner of a data analytics plugin to provide a dialog with a user, and based on the user input, generate one or more data visualizations together with a story or script accompanying or describing the visualizations.

In accordance with an embodiment, a user can generate, based on data provided by a data analytics environment (e.g., OAC) a series of pie, bar or other chart-types visualizations; and can specify, for example using a "smart suggest" option, a presentation configuration information to be sent to a large language model (LLM) environment. The (LLM) environment can process the user input and information describing a chart, and then, based on the information provided by the data analytics environment, create a language narrative or story describing or otherwise providing more information about the chart.

In accordance with an embodiment, the presentation configuration information, and other information directed to the language narrative or story, can be provided as a story exchange format, for example as a JSON data that includes information such as title, script, voice- used, and intonation. Such story exchange format operates as a standardized format for sharing information, and can then be used directly within the data analytics assistant, or can be shared with other systems or applications, for example to generate a story, podcast, or other type of presentation descriptive of the data provided by the data analytics environment. For example, in accordance with an embodiment, a story exchange format, for example as provided as a JSON data, can be shared with a third-party system or application to generate a story, podcast or other type of presentation descriptive of the data provided by the data analytics environment.

For example, in accordance with an embodiment, a story exchange format, for example as provided as a JSON data, can be shared with a third-party system or application to generate a story, podcast or other type of presentation descriptive of the data provided by the data analytics environment.

In accordance with an embodiment, the data analytics assistant allows a user to use different templates to be used with a story exchange format, to generate a story, podcast, or other type of presentation descriptive of the data provided by the data analytics environment.

In accordance with various embodiments, the described approach can be used, for example, to generate a narrated newscast or story-like video including the charts and descriptions received from the analytics environment. The same information can be packaged and sent to different third-parties, for use by their systems or applications. The approach provides a compelling way to convey objectives related to a visualization or presentation; for example, by utilizing a particular person's image, voice, or intonation, which can be generated programmatically by the system and associated with the visualization and accompanying script or description.

In accordance with various embodiment, the data visualization when displayed, can effectively narrate itself, including where appropriate using different voice-types or languages, to provide a multilingual-enabled data analytics and presentation environment.

In accordance with an embodiment, the data analytics assistant can be used to provide an analytics assistant-like interaction, including allows a user to load a dataset (e.g., in OAC) and leverage LLM to load data, index it and then search within the data.

For example, a user can open a data analytics assistant page and ask a question. A dialog allows the user to index the data for use by the data analytics assistant. A chat starter feature allows the user to click on a chart, and drag the chart into a conversation, and direct the conversation regarding that chart, in a bidirectional manner - in addition to starting from the chat environment and going to the dashboard, the user can elect to start from the dashboard and enter into the chat environment.

In accordance with an embodiment, using the above-described approach, the system can respond to a request from a user, e.g., to show a chart, and proceed to then create a story, including one or more insights which may expand beyond the original input question. In accordance with an embodiment, contextual insights may cross different dimensions of a dataset, based on correlation of the aspects therein.

When used with a data analytics system (e.g., OAC), the data analytics assistant can be used to presents the user with dynamic insights about their data which they can review and choose from, to build a presentation.

### Example User Interaction

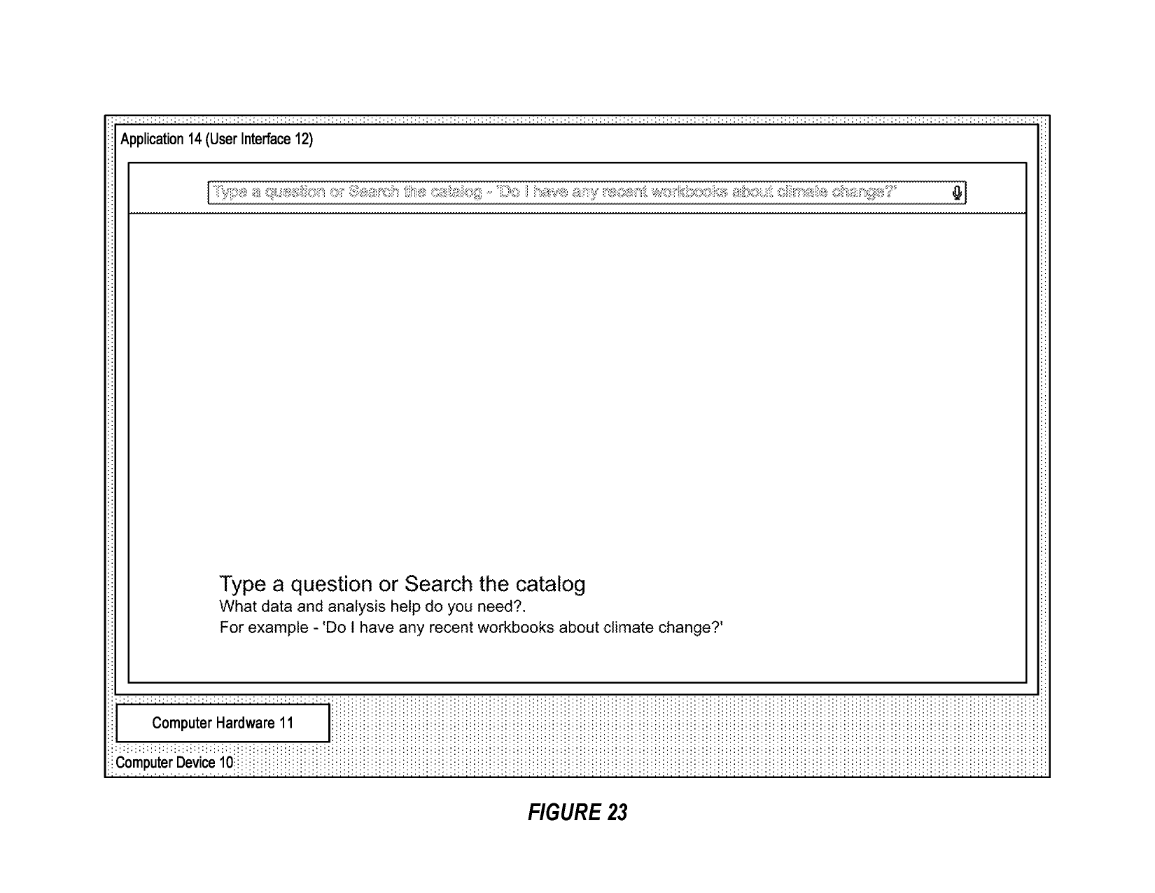

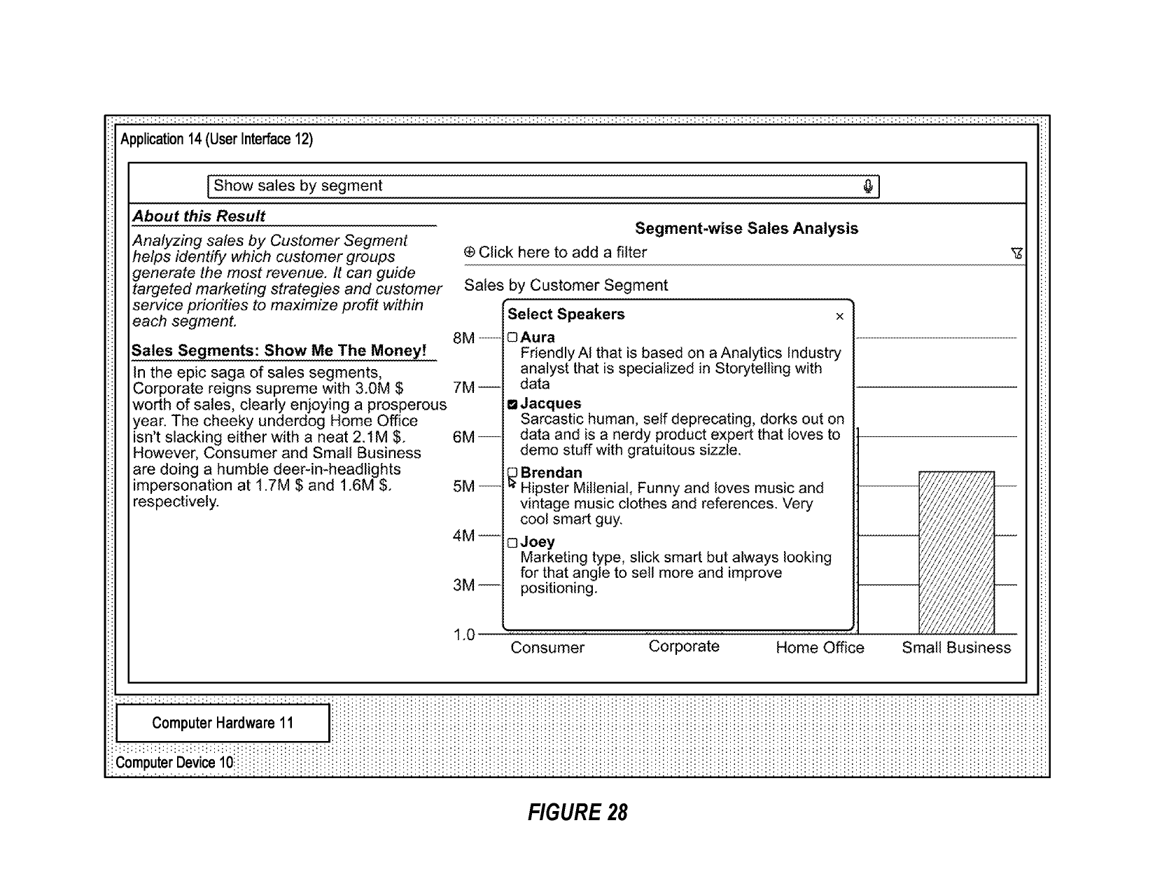

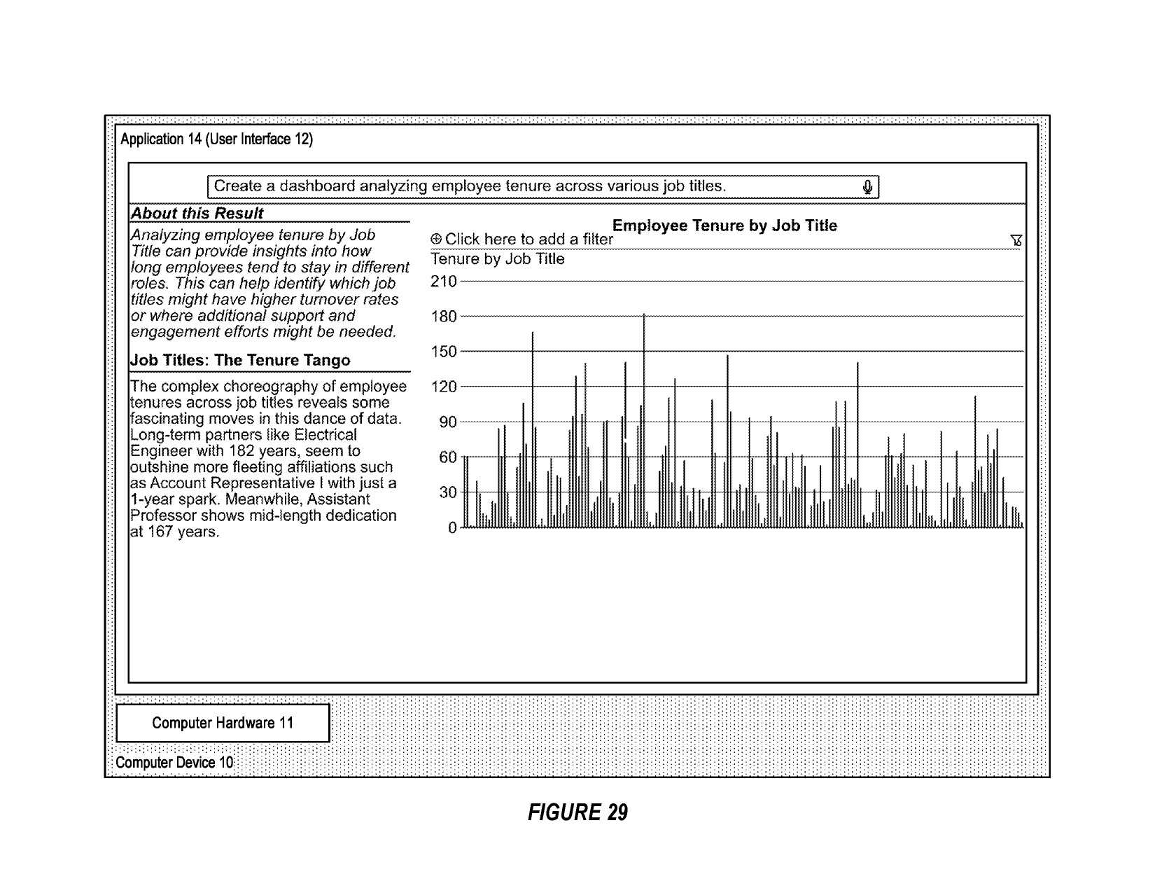

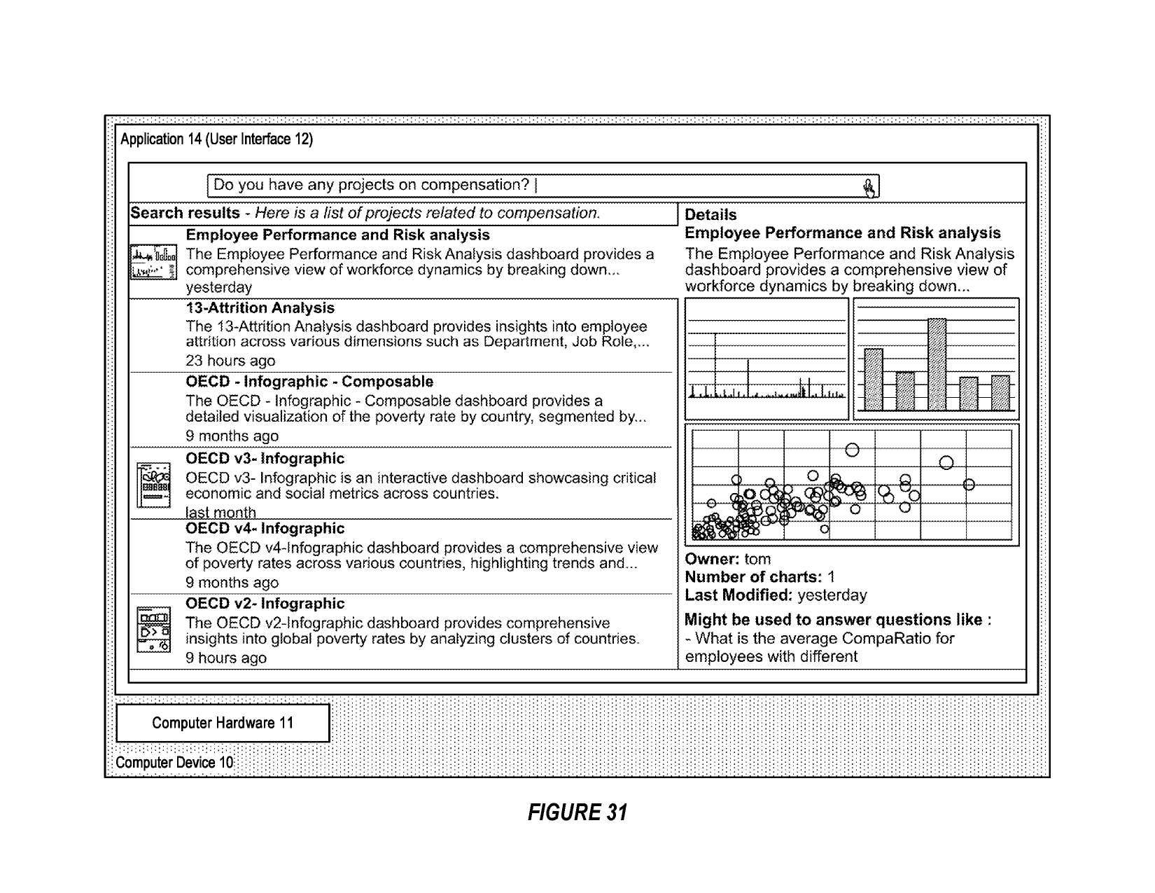

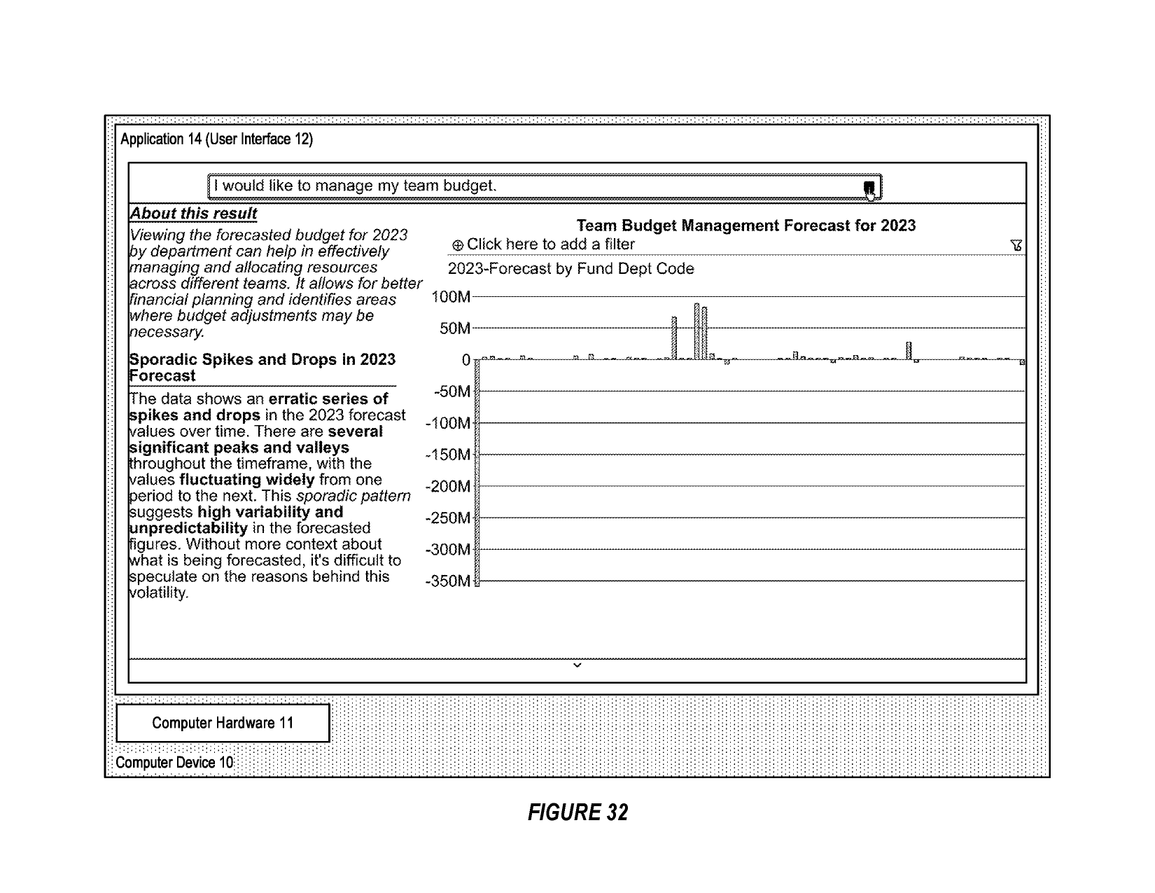

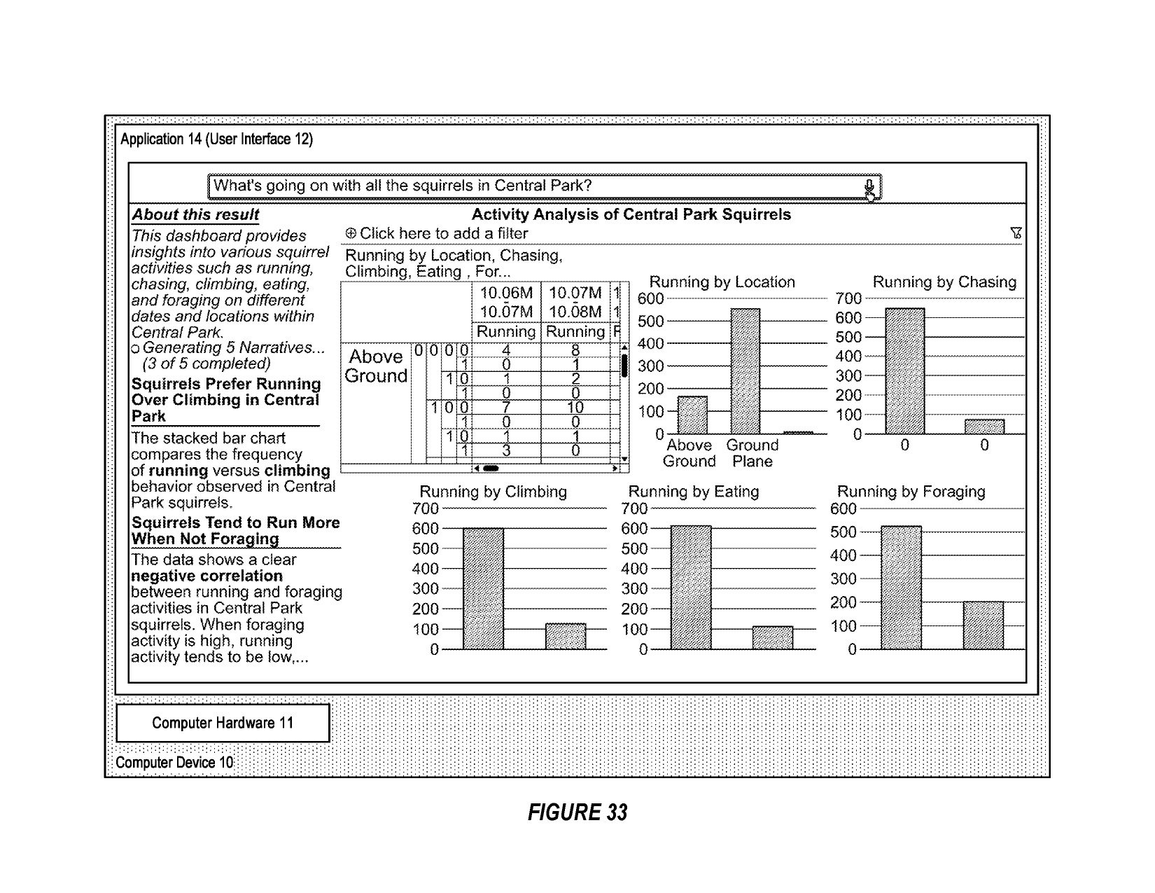

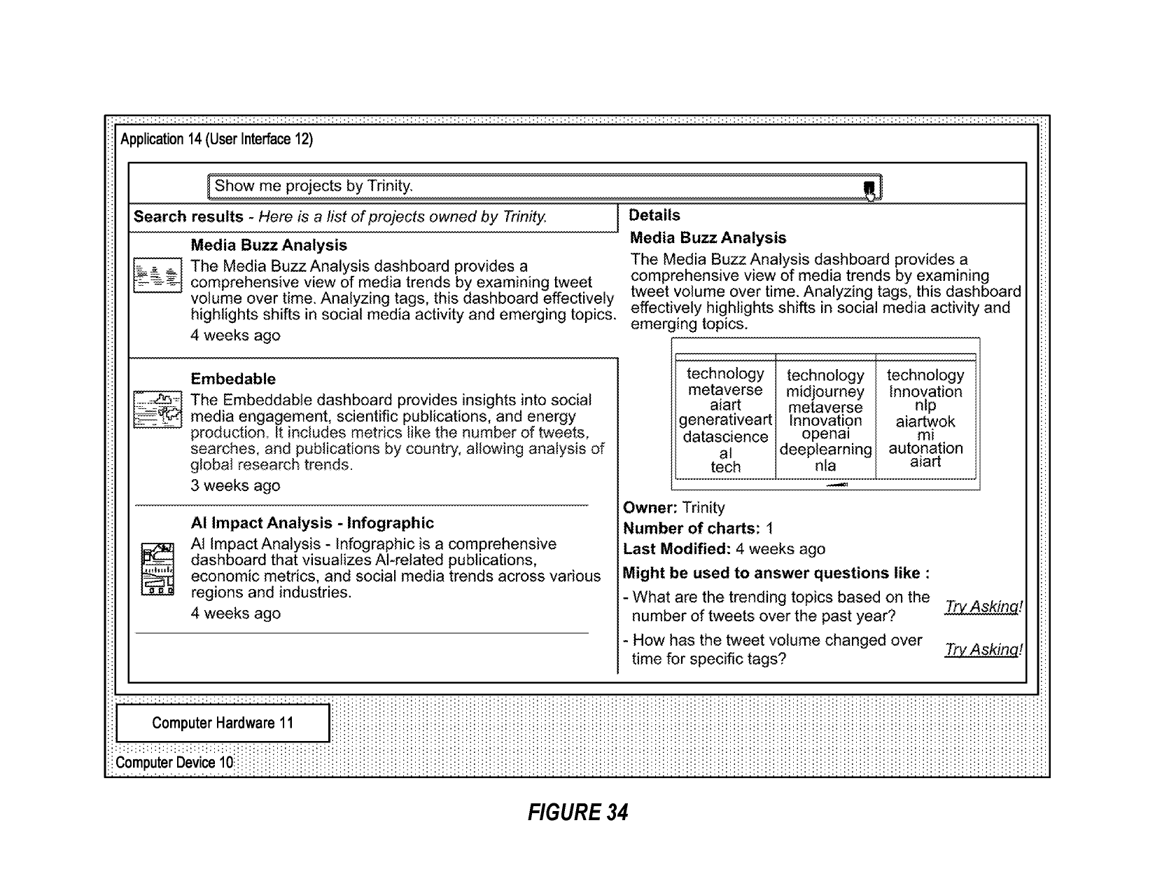

FIGS. 23-34 illustrate an embodiment in which an LLM can be used in assessing user input, in accordance with an embodiment.

As illustrated in FIG. 23, in accordance with an embodiment, the system can include an LLM-assisted user input assessment component and user interface that prompts the user to, for example "Type a question or Search the catalog", and allows the user to enter a user input in the form of a natural language query or request, such as "Do I have any recent workbooks about climate change?"

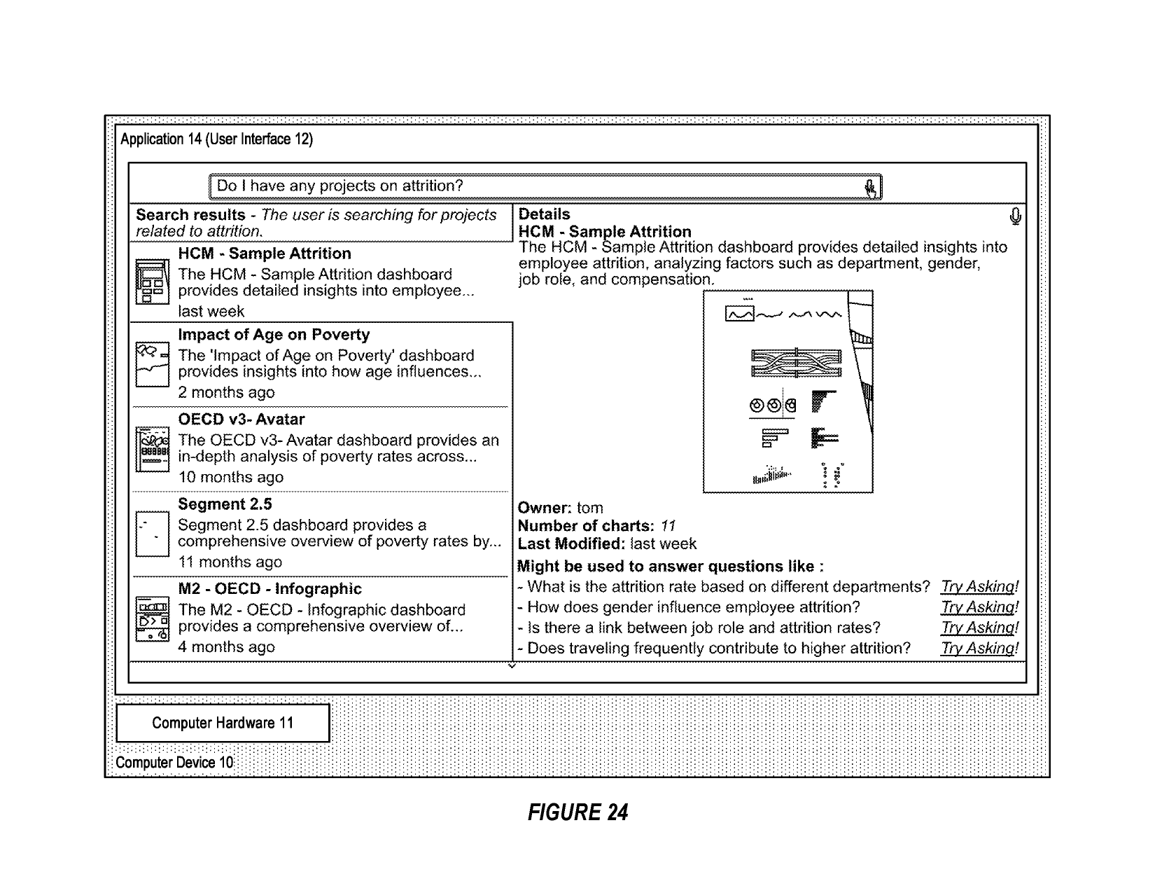

For example, as illustrated in FIG. 24, in accordance with an embodiment, the user may enter as a user input a question "Do I have any projects on attrition?"

In accordance with an embodiment, in response to said user input, the system operates with a Machine Learning (e.g., large language model, LLM) Environment, to Find, by reference to a vector database or vector store, data assets, for example data catalogs or datasets, with an affinity to the original, e.g., query or request, based on their vector similarity; determine, based on processing of the query or request by an LLM, an intent associated therewith, for example to create a workbook or dashboard; Tune, based on found data assets and responses received from the LLM, the query or request for use in addressing the determined intent and a best-fit, e.g., dataset; and route the LLM-augmented query or request for subsequent handling, for example to query the dataset and provide a data analytics or visualization to the user interface.

For example, in accordance with an embodiment, in response to a user's question as to attrition, the system can return a set of search results directed to, in this example, an HCM dataset.

In accordance with an embodiment, if a particular data catalog or dataset does not include an explicitly-defined description, the system can automatically generate a description - effectively allowing a data catalog or dataset to be self-describing. When the system generates a description for the data catalog or dataset it can also generate a set of example questions which that information, for example, the columns and rows of data in the dataset, could be used to answer. The information produced can be stored in the vector database, or a vector store, for subsequent use in determining, e.g., data catalogs or datasets that are semantically relevant to a received user input.

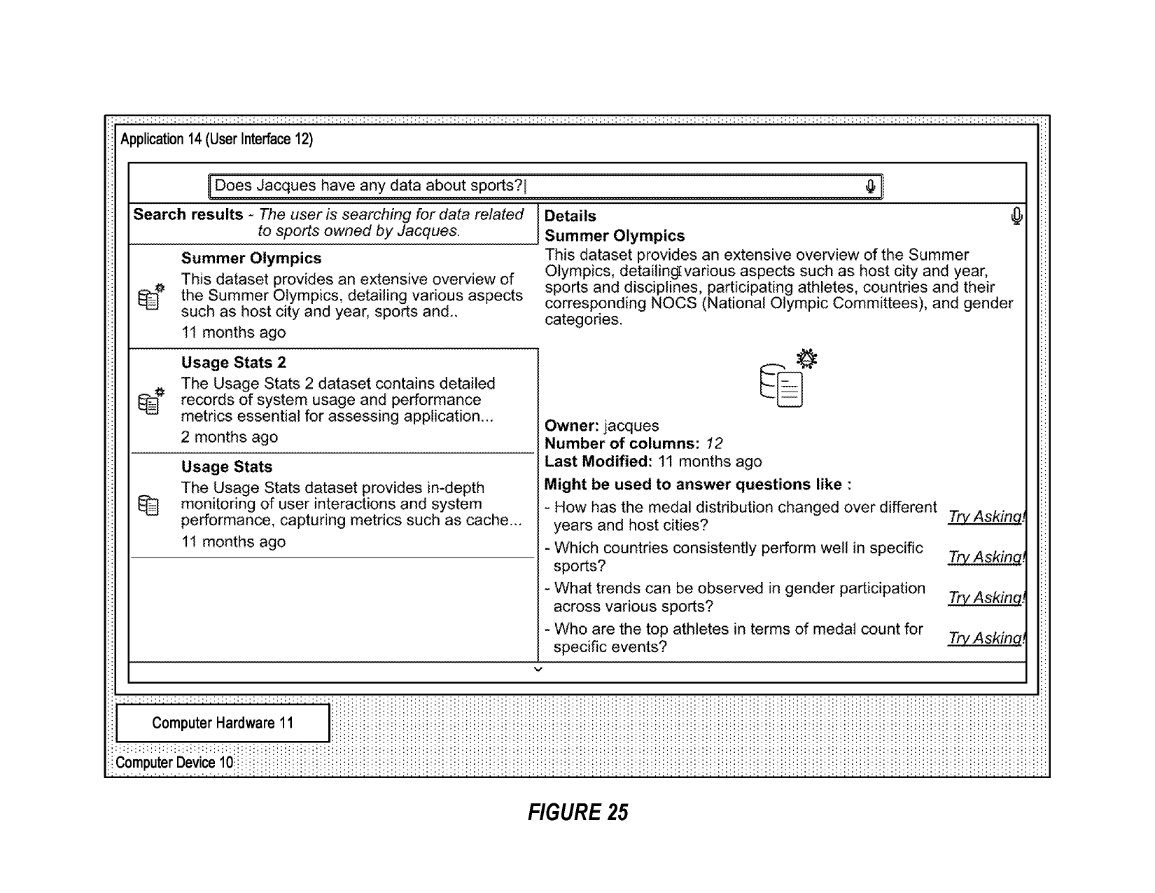

As illustrated in FIG. 25, in accordance with an embodiment, the system can be similarly used to answer user questions directed to, for example, sports, or other topics directed to other datasets.

in accordance with an embodiment, since a user's natural language input can be assessed based on vector similarity, appropriate matches can be returned, even if the specific terms used in a dataset description are not specifically indicated in the original user input.

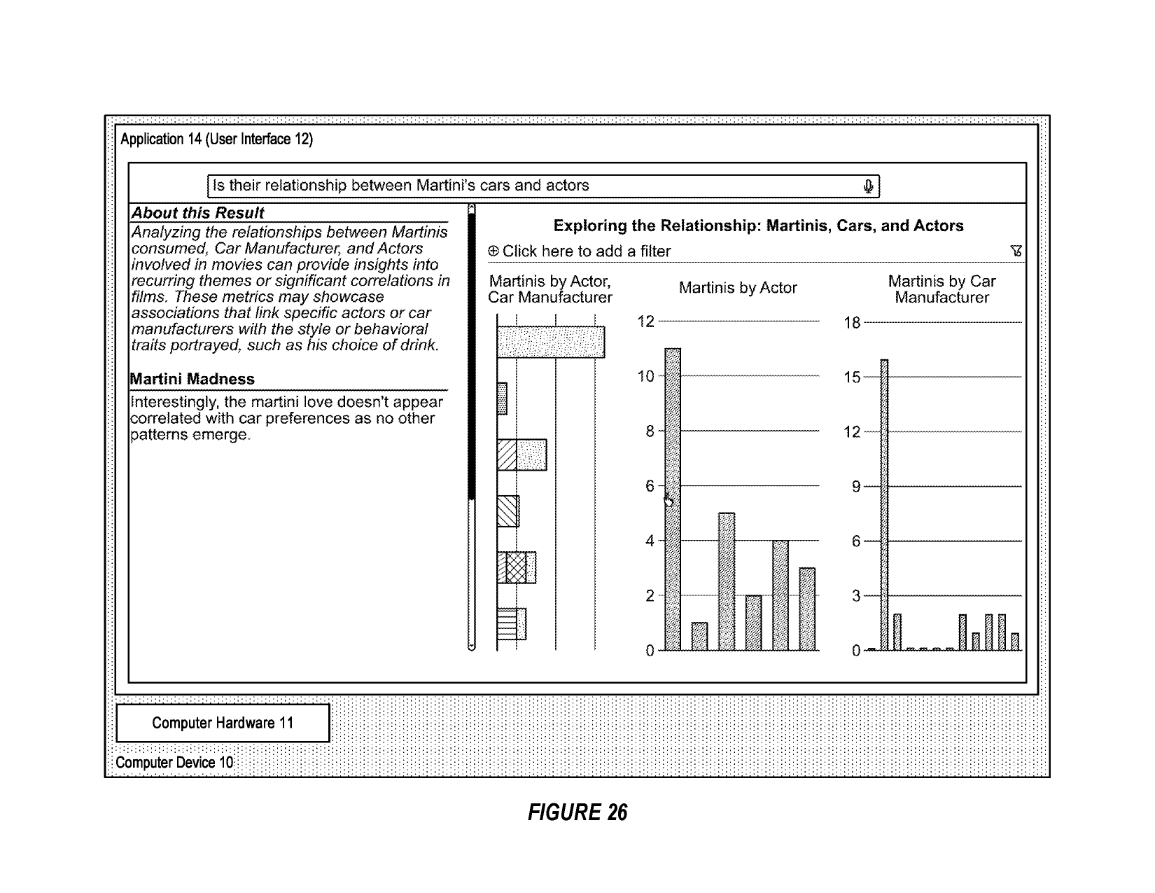

For example, as illustrated in FIG. 26, in accordance with an embodiment, a user may ask, for example, "Is there a relationship between martinis, cars, and actors?"

In response to this user input, the system can assess which datasets are closest to that question semantically, and return a set of results - in this example a variety of information related to various movies or actors.

In accordance with an embodiment, the system can highlight one or more most relevant items in the catalog in reference to a received question, and provide recommendations or narratives associated with the results. For example, in accordance with an embodiment, the system can automatically generate in real-time or on-the-fly a story, podcast, or other form of audio output which will narrate the system-generated recommendation or narrative information.

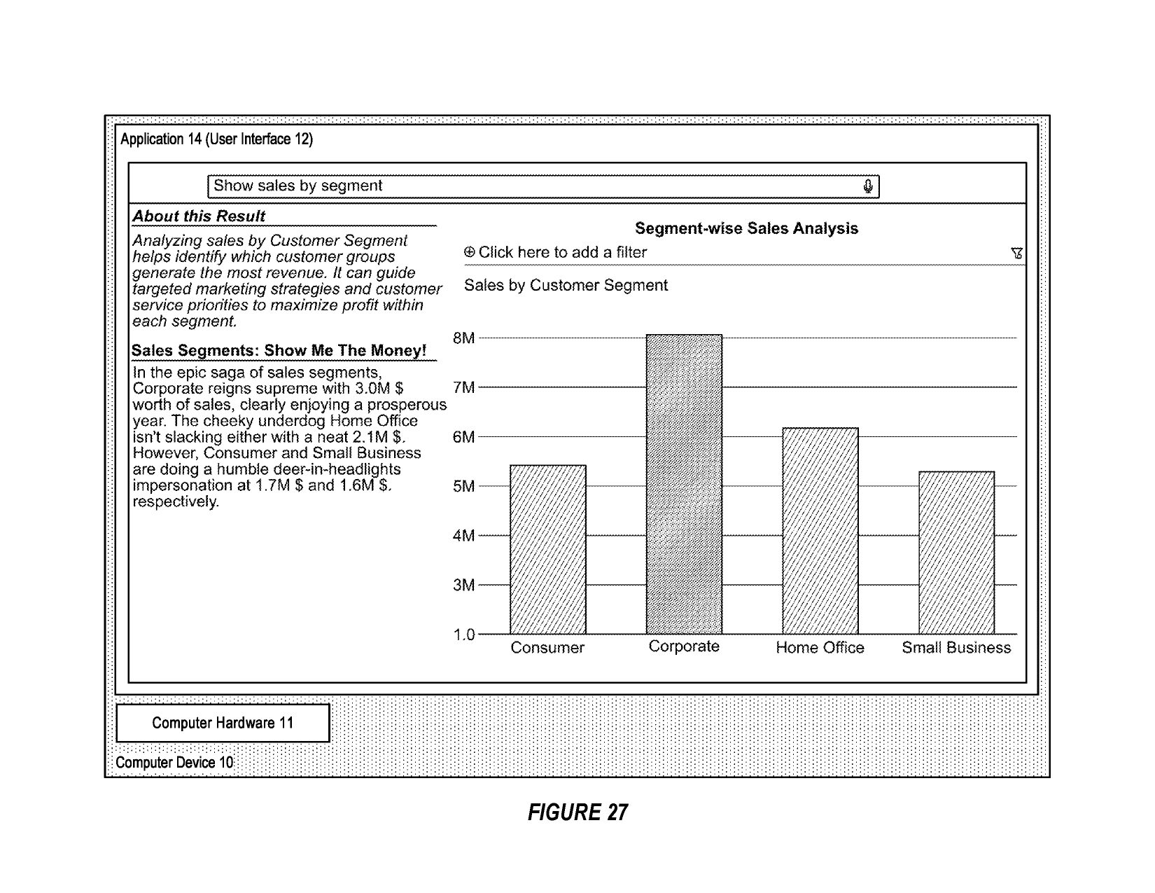

As illustrated in FIGS. 27-29, in accordance with an embodiment, a user can select from within particular users, personalities, or voices, for purpose of generating the audio narration. Using closed-captioning techniques, the audio narration can be synchronized with a dashboard or data visualizations, so that as the audio narration plays the corresponding visualization is also highlighted. This also allows the user to navigate back-and-forth between the audio narration and the visualization.

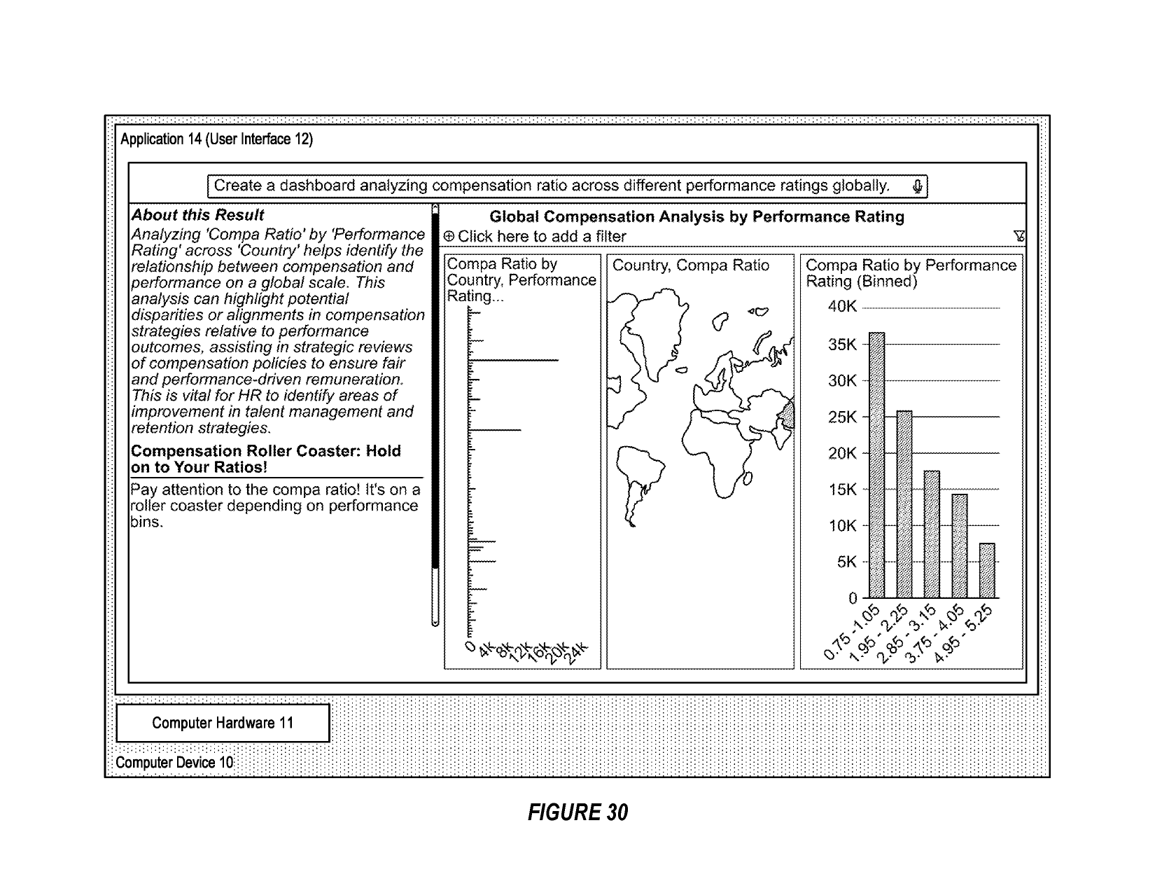

As illustrated in FIGS. 30-34, in accordance with an embodiment, the above- described approach can be similarly used to provide natural language input to assess other types of datasets, for example, employee tenure, global compensation, or other types of data.

In accordance with an embodiment, the system can present a user interface that allows the user to enter questions, or other natural language input; determine if the user input is intended, for example, as being directed to one or more target data catalogs or datasets; and process the input accordingly, for example to search for or within a particular dataset; create a dashboard or data visualization; open a data analytics workbook; or search for some information in a registered database.

In accordance with various embodiments, the systems and methods described herein can be implemented using one or more computer, computing device, machine, or microprocessor, including one or more processors, memory and/or computer readable storage media programmed according to the teachings of the present disclosure. Appropriate software coding can readily be prepared by skilled programmers based on the teachings of the present disclosure, as will be apparent to those skilled in the software art.

In some embodiments, the teachings herein can include a computer program product which is a non-transitory computer readable storage medium (media) having instructions stored thereon/in which can be used to program a computer to perform any of the processes of the present teachings. Examples of such storage mediums can include, but are not limited to, hard disk drives, hard disks, hard drives, fixed disks, ROMs, RAMs, EPROMs, EEPROMs, DRAMs, VRAMs, flash memory devices, or other types of storage media or devices suitable for non-transitory storage of instructions and/or data.

The foregoing description has been provided for the purposes of illustration and description. It is not intended to be exhaustive or to limit the scope of protection to the precise forms disclosed. Many modifications and variations will be apparent to the practitioner skilled in the art.

For example, although several of the embodiments and examples provided herein illustrate use with a cloud infrastructure, or data analytics environment such as Oracle Analytics Cloud; in accordance with various embodiments, the systems and methods described herein can be used with other types of enterprise software applications, cloud environments, cloud services, cloud computing, or other computing environments.

Although various embodiments and examples provided herein generally illustrate the use of machine learning models such as large language models (LLMs) for use in processing natural language queries or requests, embodiments of the systems and methods described herein can be used with other types of machine learning environments or models, such as but not limited to, for example, neural network models, artificial intelligence (AI) models, or various types of generative Al models such as, for example small language models (SLMs), multi-modal models, reasoning models and chain-of-thought architectures, or transformer-based models.

The embodiments were chosen and described in order to best explain the principles of the present teachings and their practical application, thereby enabling others skilled in the art to understand the various embodiments and with various modifications that are suited to the particular use contemplated. It is intended that the scope be defined by the following claims and their equivalents.

What is claimed is:

1. A system for use with a data analytics environment, comprising:
a computer including a processor and memory, and an LLM-assisted user input assessment component, wherein the system provides a user interface that allows a user to enter a user input in the form of a natural language query or request;
wherein in response to said user input, the system operates to:
find, by reference to a vector database or vector store, data assets with an affinity to the original, e.g., query or request, based on their vector similarity;
determine, based on processing of the query or request by an LLM, an intent associated therewith;
tune, augment, or otherwise adjust based on found data assets and responses received from the LLM, the query or request for use in addressing the determined intent; and
route the LLM-augmented query or request for subsequent handling, to query a dataset or provide a data analytics or visualization.

2. The system of claim 1, wherein the system operates as a data analytics assistant that provides natural language processing capabilities, for purposes of generating, modifying, or interacting with data visualizations, or generating a story or script that includes or is descriptive of the data visualizations.

3. The system of claim 2, wherein the system operating as a data analytics assistant incorporates the use of the large language model (LLM) in the manner of a front-end mechanism to assess a user’s natural language input and determine an associated intent, based on semantic similarity with available data assets, such as data catalogs or datasets.

4. The system of claim 3, wherein a user’s natural language input is assessed based on vector similarity, and appropriate matches can be returned, even if the specific terms used in a catalog or dataset description are not specifically indicated in the original user input.

5. The system of claim 1, wherein the system can determine relevant items in a catalog in reference to a received question, and provide recommendations or narratives associated with the results, for use by the system in automatically generating in real-time a story, podcast, or other form of narrative output or presentation.

6. The system of claim 1, wherein appropriate matches can be returned, even if the specific terms used in a dataset description are not specifically indicated in the original user input, wherein if upon assessing a user input, a particular data catalog or dataset does not include an explicitly-defined description, the system can automatically generate a description, allowing a data catalog or dataset to be self-describing.

7. The system of claim 1, wherein in response to a user input to the system to generate a chart, the system can use one or more LLMs to generate an interaction with the user, locate or find a dataset that has a high affinity to question, and tune or augment the question for use with the dataset so that the resulting query is best directed to an appropriate dataset or associated metric.

8. A method for use with a data analytics environment, comprising:
providing, at a computer system including a processor and memory, an LLM-assisted user input assessment component that operates with a user interface that allows a user to enter a user input in the form of a natural language query or request;
in response to said user input, performing by the computer a method to:
find, by reference to a vector database or vector store, data assets with an affinity to the original, e.g., query or request, based on their vector similarity;
determine, based on processing of the query or request by an LLM, an intent associated therewith;
tune, augment, or otherwise adjust based on found data assets and responses received from the LLM, the query or request for use in addressing the determined intent; and
route the LLM-augmented query or request for subsequent handling, to query a dataset or provide a data analytics or visualization.

9. The method of claim 8, wherein the system operates as a data analytics assistant that provides natural language processing capabilities, for purposes of generating, modifying, or interacting with data visualizations, or generating a story or script that includes or is descriptive of the data visualizations.

10. The method of claim 9, wherein the system operating as a data analytics assistant incorporates the use of the large language model (LLM) in the manner of a front-end mechanism to assess a user’s natural language input and determine an associated intent, based on semantic similarity with available data assets, such as data catalogs or datasets.

11. The method of claim 10, wherein a user’s natural language input is assessed based on vector similarity, and appropriate matches can be returned, even if the specific terms used in a catalog or dataset description are not specifically indicated in the original user input.

12. The method of claim 10, wherein the system can determine relevant items in a catalog in reference to a received question, and provide recommendations or narratives associated with the results, for use by the system in automatically generating in real-time a story, podcast, or other form of narrative output or presentation.

13. The method of claim 10, wherein appropriate matches can be returned, even if the specific terms used in a dataset description are not specifically indicated in the original user input, wherein if upon assessing a user input, a particular data catalog or dataset does not include an explicitly-defined description, the system can automatically generate a description, allowing a data catalog or dataset to be self-describing.

14. The method of claim 10, wherein in response to a user input to the system to generate a chart, the system can use one or more LLMs to generate an interaction with the user, locate or find a dataset that has a high affinity to question, and tune or augment the question for use with the dataset so that the resulting query is best directed to an appropriate dataset or associated metric.

15. A non-transitory computer readable storage medium, including instructions stored thereon which when read and executed by one or more computers cause the one or more computers to perform a method comprising:
providing, at a computer including a processor and memory, an LLM-assisted user input assessment component that operates with a user interface that allows a user to enter a user input in the form of a natural language query or request;
in response to said user input, performing by the computer a method to:
find, by reference to a vector database or vector store, data assets with an affinity to the original, e.g., query or request, based on their vector similarity;
determine, based on processing of the query or request by an LLM, an intent associated therewith;
tune, augment, or otherwise adjust based on found data assets and responses received from the LLM, the query or request for use in addressing the determined intent; and
route the LLM-augmented query or request for subsequent handling, to query a dataset or provide a data analytics or visualization.

16. The non-transitory computer readable storage medium of claim 15, wherein the system operates as a data analytics assistant that provides natural language processing capabilities, for purposes of generating, modifying, or interacting with data visualizations, or generating a story or script that includes or is descriptive of the data visualizations.

17. The non-transitory computer readable storage medium of claim 16, wherein the system operating as a data analytics assistant incorporates the use of the large language model (LLM) in the manner of a front-end mechanism to assess a user’s natural language input and determine an associated intent, based on semantic similarity with available data assets, such as data catalogs or datasets.

18. The non-transitory computer readable storage medium of claim 17, wherein a user’s natural language input is assessed based on vector similarity, and appropriate matches can be returned, even if the specific terms used in a catalog or dataset description are not specifically indicated in the original user input.

19. The non-transitory computer readable storage medium of claim 15, wherein the system can determine relevant items in a catalog in reference to a received question, and provide recommendations or narratives associated with the results, for use by the system in automatically generating in real-time a story, podcast, or other form of narrative output or presentation.

20. The non-transitory computer readable storage medium of claim 15, wherein appropriate matches can be returned, even if the specific terms used in a dataset description are not specifically indicated in the original user input, wherein if upon assessing a user input, a particular data catalog or dataset does not include an explicitly-defined description, the system can automatically generate a description, allowing a data catalog or dataset to be self-describing.
